(19) United States
(12) Patent Application Publication
(10) Pub. No.: US 2010/0268661 A1
(43) Pub. Date: Oct. 21, 2010

(54) Recommendation Systems

(75) Inventors: Kenneth L. Levy, Stevenson, WA (US); Neil E. Lofgren, White Salmon, WA (US)

Correspondence Address: KENNETH L. LEVY, 110 NE CEDAR STREET, STEVENSON, WA, 98648, US

(73) Assignee: 4-TELL, INC, Stevenson, WA (US)

(21) Appl. No.: 12/764,091

(22) Filed: Apr. 20, 2010

Related U.S. Application Data
(60) Provisional application No. 61/171,055, filed on Apr. 20, 2009.
(60) Provisional application No. 61/179,074, filed on May 18, 2009.
(60) Provisional application No. 61/224,914, filed on Jul. 13, 2009.
(60) Provisional application No. 61/229,617, filed on Jul. 29, 2009.
(60) Provisional application No. 61/236,882, filed on Aug. 26, 2009.

(51) Int. Cl. G06Q 99/00; G06F 17/30

(52) U.S. Cl. 705/347; 707/748; 707/E17.044; 707/705

(57) ABSTRACT

This invention deals with recommendation systems. The first embodiment is an off-the-shelf recommendation system is described, where it is easy to integrate with the website database and uses a web service for recommendations, as well as easy to integrate with email. The system receives client ID, item ID and user ID, and returns recommended item IDs. The recommendations include similar items, related items, related users, items likely to be acted upon by a given user (labeled likely items), and users likely to act upon an item (labeled likely users). The recommendations include categorical training, where recommended items are based upon similar categories, where the category types include as product type and brand. The recommendations include similar-to-related training, where similar items are used to find related items. These two intelligent methods work for items with no, few or numerous actions.

This application claims the benefit of Provisional Patent Applications Ser. No. 61/171,055 filed Apr. 20, 2009, Ser. No. 61/179,074 filed May 18, 2009, Ser. No. 61/224,914 filed Jul. 13, 2009, Ser. No. 61/229,617 filed Jul. 29, 2009, and Ser. No. 61/236,882 filed Aug. 26, 2009, all entitled “Improvements in Recommendation Systems”, and all incorporated herein by reference.

### TECHNICAL FIELD OF INVENTION

The present invention relates to recommendation systems, data mining, and knowledge discovery in databases.

### BACKGROUND OF THE INVENTION

Recommendation systems have been developed for large e-commerce websites and have been reported to account for 35% to 75% of transaction. However, these systems are customized, thus, expensive to develop and not easily adaptable to other websites, especially websites with few sales and products with 6 month lifecycles. They do not work off-the-shelf, requiring customization and difficult integration with the websites.

Many existing recommendation systems, such as K nearest neighbors (KNN), only use positive correlations. This includes Amazon patents (U.S. Pat. Nos. 7,113,917, 6,317,722, 6,266,649, 6,064,980, 6,912,505, and 6,853,982, included herein by reference), Netflix patent (U.S. Pat. No. 7,403,910, included herein by reference), and Slope One methods (Slope One”, http://en.wikipedia.org/wiki/Slope_One, Aug. 6, 2007 included herein by reference). It also includes Hack Netflix Prize blog entry (Hack Netflix Prize, http://dmnewbie.blogspot.com/2007/09/greater-collaborative-filtering.html, Feb. 5, 2009, included herein by reference), and papers by Bell and Koren (“Improved Neighborhood-based Collaborative Filtering” KDDCup'07, Aug. 12, 2007; “Modeling Relationships at Multiple Scales to Improve Accuracy of Large Recommender Systems”, KDD'07, Aug. 12-15, 2007; and “The BellKor solution to the Netflix Prize”, Netflixprize.com, Nov. 22, 2007—included herein by reference). There are also rumors about Amazon trade secrets around “people who bought related items, also bought . . . ”, as discussed in the blog “Amazon: Customers Who Bought Related Items Also Bought” http://thenoisychannel.com/2009/01/31/amazon-customers-who-bought-related-items-also-bought/, Jan. 31-Feb. 2, 2009.

Furthermore, when using correlation to estimate a rating, these references, as well as others prior art, use only related items or related users in each step, but do not use actions from related users on related items in the prediction.

Matrix simplification turns historical data representing actions between items and users into two simpler matrixes. The actions can include item purchases (including rentals), media plays, links between social objects, such as friends and groups, ratings, and webpage views. Singular value decomposition (SVD) turns the historical data into two simpler matrices include one matrix of items versus features, and one matrix of users versus features. These two simpler matrices can be used to estimate user-items pairs by multiplying the item features by the user features.

Using SVD, via an iterative training method, to estimate item ratings in Netflix was published by Simon Funk (real name Brandyn Webb) in several web posts (“Netflix Challenge”, http://sifter.org/˜simon/journal/20061027.2.html, Oct. 27, 2006; “Netflix Update: Try This at Home”, http://sifter.org/˜simon/journal/20061211.html, Dec. 11, 2006; and “Netflix SVD Derivation”, http://sifter.org/˜simon/journal/20070815.html, Aug. 15, 2007—all included herein by reference). Further SVD information is available from Timely Development (“Netflix Prize”, http://www.timelydevelopment.com/demos/NetflixPrize.aspx, Sep. 17, 2008, included herein by reference), and John Moe (“My modifications”, http://www.johnmoe.com/svd.html, Aug. 6, 2007, included herein by reference). These methods use the historical item ratings, where ratings are integers 1 (really disliked) through 5 (really liked). Comparing items with the largest or smallest feature for one of the features has been discussed by Funk (references above) and Pragmatic Theory (“There is evil there that does not sleep; the Great Eye is ever watchful”, http://pragmatictheory.blogspot.com/2008/10/there-is-evil-there-that-does-not-sleep.html, Oct. 14, 2008). However, no method uses all of the feature data to find related items or users. Furthermore, no method rates all of the items to find items that a user will most likely like, or users that will most likely like an item. In addition, SVD methods have only been applied to data with ratings, not actions without ratings.

Social networks allow users to link to other users, called friends, participate in groups, such as those interested in matrix simplification, or more likely football, and share information, including pictures, music, stories, current activities, interests, etc. Social networks suggest friends based upon text, such as home town, college name, company name of employer. Social networks also let user meet through groups that the user finds by search, or friends suggest. Social networks don't make suggestions based upon either user actions within the social network or outside the social network. Affinity cards allow users to receive discounts with one or more stores or companies, and sometimes use it for credit. However, these systems don't provide recommendations or discounts based upon recommendations.

### SUMMARY OF THE INVENTION

This patent application traverses the numerous limitations discussed in the background. It describes a simple system for web, email mobile commerce, social media, and even phone, and provides six basic types of recommendations:
Similar Items—Items that are comparable or alike to a target item. They can be in the same categories, related to the same items, or viewed together. They can be ranked by number of actions, or strength of relationship to the same item, and usually shown to the user when the user is browsing items.
Related Items (a.k.a. Cross-Sell Items)—Items that are bought with the target item, top selling items from categories that are related to the target item's categories, or items that are related to items similar to the target item. They are ranked by similarity, and usually shown to the user when the user is browsing and/or in the process of acting upon (i.e. buying) the item.
Likely Items (a.k.a. Up-Sell Items)—Items that a user is likely to act upon by a target user based upon the target user's action history. They are ranked by likelihood, and usually shown to the user when the user is checking out or in email.
Related Users—Users that act on many of the same item as the target user. They are ranked by similarity, and used to link users via social networks, comments, forum, blogs, etc.
Likely Users—Users that are likely to act on a target item. They are ranked by likelihood, and used to promote an item in mail, on the web, or in email.
Estimated Rating—The estimated rating for a target user and target item pair.

There are numerous methods to calculate each of these recommendations, and the preferred embodiment shows recommendations from each method of calculation within the type of recommendation, and potentially recommendations from each of the six basic types.

One embodiment of this invention is a recommendation system that works off-the-shelf by exporting historical action data or linking to the client's website action database, using novel or existing training algorithms, creating recommendation tables from the six basic recommendation types, and requesting information for the client. The recommendation system can be a computer program whose input is a configuration file that includes a list of historical data files. Furthermore, the recommendation system easily connects to any website using a web service that is called by the client's website that receives client, user and/or item IDs and returns recommendation IDs from the recommendation table. The recommendation web service can run behind the same firewall as the client's website database or be hosted elsewhere, such as on the Internet in a physical or virtual server (i.e. in the cloud).

The system can display recommendations for a website. The recommendations can come from any method, including matrix simplification. Similar and related items can be shown when a user is viewing an item. Likely items can be shown when the user logs in, is viewing an item, or the shopping cart. Related users can always be shown and help users meet and discuss items in a forum or social network, or even date. Combinations of the above can be shown, such as one related item, one likely item, and one promotion. Furthermore, items that have already been acted-upon and labeled as sell-once can be skipped by checking recommended item IDs versus historical data.

The system can also connect to a user email system in several ways. First, the email list contains only the likely users for an item so that users don't receive too many emails and opt out. Second, the email inserts likely items for the recipient user at creation, possibly limited to a list of a few, such as 20, likely items so it's easier to manage. Third, the email includes a dynamic link, which upon opening the email updates an email template to include images of likely items and links to likely item web pages, again possibly limited to a list of a few items so it's easier to manage.

In many real-world situations, the actions are not numeric (i.e. non-rated). This is also known as a nominal value in measurement theory. (A rating is ordinal since a higher rating is better than a lower rating, but the difference between a 1 and 2, and a 2 and 3 are not defined.) The target item, user pair actions (meaning that an action includes a user and an item, in other words, a user acting on an item) in the historical data can be represented by a numeric value in several fashions. In the simple conversion method, one or more actions are represented as a 1, or inherently by saving the target item and user ID pair as an action (i.e. sale). For the repeat conversion method, the count value for the target pair is the number of actions by the target user on the target item. For the scaled conversion method, the number of actions are scaled by total actions, maximum actions, or logarithm, such that proportional relationship are converted to offset, where offset works best with most training algorithm, especially those based upon Pearson. Finally, a sigmoid or related conversion method can be used. In this method, for a value of 1, the estimates for a user and item pair are interpreted in terms of likelihood of action, such as a purchase, rental, play, etc. Furthermore, the first action can be turned into a number near one, like 0.8, and additional actions increase the rating further towards 1—such as using a sigmoid function. In this case, which is especially useful for items that a user re-uses, numerous actions increase the likelihood of future actions.

For data with both rated and non-rated actions, the number of ratings versus non-rated actions is usually not known. The preferred algorithm analyzes the number of rated versus non-rated actions, and automatically decides between an algorithm for non-rated actions and an algorithm for rated actions. When using non-numeric actions and rated items, the non-numeric actions take a value at or above the median rating, such as a 4 for ratings between 1 and 5, with 5 as the best.

Furthermore, the historical data could be the number of items ordered by a dealer or distributor. When estimating related items or users, since larger distributors order more items than smaller distributors by ratios, the scaled conversion is used. When estimating the number of items that a distributor (or dealer) should order from a manufacturer, the number of items ordered in the historical data is used (i.e. repeat conversion method). The estimates can be subtracted from the actual number of each item ordered and multiplied by the price, cost-of-goods-sold (COGS), or price minus COGS (i.e. profit) to determine the economically optimal recommendation. The price and COGS can be used with any recommendation to optimize for revenue, cost or profit.

A method to combine related items and estimated ratings can be used to optimize recommendations when the target item and user are both known, and there are ratings. The process can also uses any method to find items related to the target item, and then rate the related item to organize them to present to the user. The user could be a consumer with ratings or a distributor with order sizes as ratings.

Additionally, if target item ID and target user ID are known, a recommended item that occurs in both the related items for the target item and likely items for the target user can be returned as a recommendation, and if not enough exist, related items and likely items can be combined and organized by likelihood, and finally, top selling items can be chosen to complete the number of requested recommendations.

Furthermore, items similar to a new item can be used to determine how many of a new item to build or buy (or any action). When estimating ratings and the ratings are order size, the inventory estimate is the multiplication of the sum of the estimated rating for all users by a scaling factor related to how many users acted upon the similar item. It's preferable to use several similar items and average the results. When using non-rated methods, the likelihood for items related to the similar item is used. The inventory estimate is the multiplication of the likelihood by the number of actions upon the item related to the similar item, summed for numerous related items.

Items can be tagged as re-use or use-once, where use-once items are skipped if the user has previously acted-on that item. The re-use can be tagged via categories. Category tags can also include more detailed categories, such as clothes, devices and supplies, and used to both determine re-usability and recommendations. For example, clothes and supplies are re-use, whereas devices are use-once. The tags can also be automatically determined using the self-similarity method (described below).

Finally, the system includes a control panel, which is used to control recommendation touts using a few parameters that control the response of the recommendation web service. The parameters determine if the web service should respond with best, similar, related, likely, promotion, or top selling items, and if the response should change if the likelihood and/or number of common users is below a minimum value. Importantly, this enables promotions to intelligently be included in recommendations, ordered with other top sellers as well as suggested with the proper category. The control panel also allows promotional items to be pre-weighted with artificial sales or artificial similarities with other items (such as a bikini top and bottom or windsurf sail and mast). Finally, the control panel can include a maximum price to limit recommendations' price (assuming that the price is included with the item ID).

Similar items are determined by several methods. In the first method, similar items are determined from top sellers in the same categories as the target item. In the preferred embodiment, product type and brand are used as the category types. In the second method, similar items are determined from items that are related to the same item but not related to each other. In the preferred embodiment, brute force is used where, for a target item, the system searches each related item to find subsequent related items (those related to the related items) that are not related to the target item. In another embodiment, grouping techniques use the similarities, such as using the inverse of the similarities as the distances, to determine clusters of items. The grouping techniques can be clustering, Kohonen self-organizing maps or gravity based clustering. The similarities are from any or all of the methods to determine related items. The cluster includes items with few users in common, which are similar items (such as two different belts that go with the same pants), and items with several users in common, which are related items (such as pants and a belt). In the third method, similar items are determined from items viewed by the same user (i.e. related items based upon views and not actions). The results from each method are optimally combined to increase the diversity of recommendations.

Related items are determined by using a similarity measurement between item pairs based upon users who acted on both items, labeled item-to-item related items. The preferred measurement is the Cosine similarity weighted by threshold added to the denominator. The threshold depends upon the average number of actions per item divided by a factor (such as 250), and has a minimal value, such as 5.

In a method labeled genomic related items (a.k.a. categorical related items), related items are determined using categories. Several items belong to a category. In this embodiment, the similarity between categories is found using any training algorithm that does not remove repeat actions. In addition, the self-similarity of a category with itself is found. A preferred embodiment for the self-similarity is dividing the number of users with multiple actions by the total number of users (or total number of actions by users with multiple actions divided by the total number of actions). After determining category similarities, the target category is determined from the target item, the most related categories to the target category are determined, the top selling items in each related category are listed, and the items with the largest factors are used to determine the categorical related items. The factors are based upon the number of item actions and the category similarity. The target item can belong to several categories, resulting in several target categories, and each target category is used in determining the most related categories. There can also be multiple category types, and the similarity within each category type between the target item's category and the other categories for both category types are used to determine the related items. More specifically, the recommended item must belong to similar categories in both category types. In the preferred embodiment two category types are used, including product type and brand. Additionally, as mentioned above, self-similarity for items can be used to automatically determine if the item is re-use or use-once, as items with a large self-similarity are re-use item and ones with a small self-similarity are use-once.

In a method labeled similar-to-related items, related items are determined using items similar to the target item. In this method, the similar items for the target item are found. Then, the related items for each similar item are combined to a final list. The items in the final list with the largest likelihood value are the related items. This method is synergistic with categorical related items since it can find related items that are not top sellers (i.e. in the long tail), and categorical related items are top sellers.

Related items can be ranked by both the similarity measurement (also called the likelihood factor since it estimates the likelihood a user will act on both items), and by rules that result in recommendations from various categories. These rules increase user actions by providing diverse but relevant recommendation. For example, a rule is that recommendations should be from 3 categories, if possible. In other words, the recommendation is ranked based upon both its likelihood factor and previous recommendations.

Likely items are determined from combining items related to items acted upon by the target user. When an item is related to more than one acted-upon item, the similarities are summed. The actions can be based upon the most recent time period or most recent number of actions, and the preferred embodiment uses six months of actions. Likely users are determined from combining users related to users that acted on the target item. Once again, when a user is related to more than one user that acted on the target item, the similarities are summed. Likely users can also be calculated as those with the highest estimated rating for an item.

Alternatively, users that acted upon several of the related items to the target item can be used as likely users. The method is preferred since it doesn't require computing the large array of user-to-user similarity, especially when a large number of likely users are desired. More specifically, the likely users are determined by listing numerous related items to the target item, and combining users of the related items. Users of the target item are also included, if it is tagged as re-use. Likely users are used to focus promotions, such as mail or email campaigns to promote a specific item. Likely items can be used in promotions, and the list included in mail or email campaigns to specific users—maybe users that have not bought in a while and users with a surge in recent activity. Whenever summing similarities, a sigmoid, such as x/(1+x), is preferably used as the last step to keep the value between 0 and 1.

There is a hierarchical approach that enables best recommendations and to fill out recommendations if not enough exist. The basic hierarchy is:
Level 1: Item-to-Item
   Item-to-item related items
   Likely items based upon item-to-item related items
Level 2: Intelligent
   Categorical related items
   Similar-to-related items
   Likely items based upon categorical related items
   Likely items based upon similar-to-related items
Level 3: Similar
   Similar items
Level 4: Top Sellers
   Top sellers for all historical data

Requests enter in the correct hierarchical level, and keep falling down to fill out recommendations. Items in each hierarchical level can be combined to find optimal recommendations, but a lower level cannot replace a higher level. Furthermore, if likely items are requested and one or more target item IDs are included, related items should only be used to boost existing likely items, unless not enough likely items are available. Similarly, if related items are requested and a target user ID is included, likely items should only be used to boost existing related items, unless not enough likely items are available. Promotions can also be included in the recommendations by replacing items with similarities/likelihoods below a threshold, if not enough recommendations exist within the specific type, or as defined by the control panel.

Another embodiment of this invention includes a recommendation system that uses both positive (i.e. related) and negative (i.e. opposite) correlations as the basis for weights to create estimated ratings. The estimated rating includes negative and positive weights to calculate the weighted rating in the numerator, and the absolute value of the weight to predict the total weight in the denominator. A predetermined number of weights with largest absolute values are used, called K most predictive neighbors (not nearest neighbors since the neighbors with negative correlations are far apart, but very predictive). In other words, the K weights could all be positive, negative or any combination of positive and negative weights depending upon the absolute values. These weights are possibly further scaled by the number of common users or items, and/or by the confidence level of the weight.

Another embodiment of this invention includes a recommendation system that creates rating estimates for a target user, target item pair from combinations of predictive users and predictive items, where predictive means that the user or the item has a large correlation magnitude with the target user or target item, respectively. The system utilizes a predetermined number, i.e. K, most predictive neighbors, where the largest weight magnitudes are chosen from the set of the weights of predictive items, weights of predictive users, and multiplication of the weight of a predictive user and weight of a predictive item. In other words, previous systems used ratings from a target user and neighbor item or a target item and neighbor user, but this system uses ratings from a target user and neighbor/predictive item, a target item and neighbor/predictive user, or neighbor/predictive user and neighbor/predictive item.

Even another embodiment of this invention includes a recommendation system that uses matrix simplification techniques, such as SVD, to create item features and/or user features, and then uses the correlation of two or more item features or user features to find related items or users, respectively. Related items or users are those objects with the largest correlation values. The correlation method can use Pearson, or Kendall Tau, or use similarity methods such as Cosine or Euclid distance, or other point base ranking. A novel scaled, ranking point method, ranks item's or user's similarity to a target item or user, respectively. In this method, the points are assigned to reduce the effect of the feature with a higher index. The matrix simplification method can also be used to estimate the ratings for all user-item pairs, and then utilize these ratings to find likely items and/or likely users.

Another embodiment of this invention solves an unnoticed problem. The problem is based upon the finding that if the historical data is non-rated, it is represented by a single value, such as 1, for each action, and SVD, or any matrix simplification method, will converge to that single value for every feature—an uninteresting solution. Even if a method is used to differentiate items acted upon one or more times, the matrix simplification solution differentiates items by number of actions, not likelihood of an action versus no action. The solution is to first train and find disliked user-item pairs (labeled dislikes). Matrix simplification methods can be used to find dislikes, where 0's are used for non-acted-upon user-item pairs, and the lowest values after training are selected as dislikes. Dislikes selection can be done per each user, per each item, or globally. Selection can be use the smallest values, or randomly select values below a threshold, set via statistics and verified via dislike selection ratios to be a reasonable value. Correlation methods can be used to find dislikes, where, for each user, the least related items become dislikes. The least related items are based upon combining similarity weights for each item utilizing all items acted-upon by that user. Alternatively, K items with smallest similarity weights after summing across all items acted-upon by the target user can be combined to find the dislikes. Similarly, the K items can be randomly chosen from items not included in the list of items with large weights. The number of dislikes is usually related to the number of actions, in total or for each user. Equivalently, these methods can be used based upon items rather than users. After finding dislikes, the resulting matrix is created with ones for items acted upon by a user and zeros for item-user pair dislikes, and then trained using the matrix simplification method.

A further embodiment of this invention includes methods of connecting users that are related based upon actions on a website to a social network or within the client's website. For example, a user can be shown a related user's comment on a forum, or the related user's ratings of items. The benefit is that comments and ratings from a user with similar buying habits is usually more relevant. Additionally, the social network can be a different website than the one that introduced the users, preferably maintaining a link to the website that introduced them. If the related user doesn't have a profile on the social network, the related user can be prompted to create one and then be automatically linked to the user that originally requested the connection. Furthermore, actions within a social network, such as links to social objects, to suggest friends and groups or other social objects within a social network can be used to connect related users, connect users to social objects related to the one they are viewing, or recommend social objects they are likely to enjoy.

Another embodiment includes methods of recommending likely items and/or providing discounts for likely items for affinity cards. This includes training with the offline database of two or more cardholders, and using actions from one affinity card to determine one or more likely items for that card. Likely items can be used to create discounts for one or more likely items, electronically transmitted to the card reader, and displayed to the user, or printed for the user, when using the affinity card such as at the local supermarket during checkout. Preferably, only likely item available at that store is displayed.

### BRIEF DESCRIPTION OF DRAWINGS

FIG. 1 shows the architecture for a recommendation system.

FIGS. 2A-2B show the pseudo code for the recommend component of the system which includes 2 stages.

FIGS. 2C-2D show the two training validation methods.

FIG. 2E shows the workflow for the website to interact with recommendations.

FIG. 2F shows the workflow for email to interact with recommendations.

FIG. 2G shows an example control panel configuration file.

FIG. 2H shows a method to find related items from categories.

FIG. 2I shows a method to find related items based upon similar items.

FIG. 2J shows a method to arrange related items for the specific user.

FIG. 2K shows a method to estimate inventory usage using order size or likelihood of purchase.

FIG. 2L shows a process to filter recommendations based upon user actions, user and item categories.

FIG. 3A shows the architecture for recommendations using correlation for non-rated data.

FIG. 3B shows example data for calculating similarities using repeat actions.

FIG. 3C shows example data for calculating self-similarities.

FIG. 3D shows the workflow to find similar items using brute force.

FIG. 3E shows the workflow for genomic training based upon categories.

FIG. 4A shows the user and item matrix used to determine the recommendation using correlation and predictive users, predictive items, and predictive user and predictive item combinations.

FIG. 4B shows the same matrix as in FIG. 4A with some ratings missing as true in the real-world.

FIG. 4C shows the workflow for recommendations using correlation and predictive users, predictive items, and predictive user and predictive item combinations.

FIGS. 5A-5F show the pseudo code for the training component of the recommendation system, which includes six stages.

FIG. 5G shows the points used in the scaled, ranking points method for training.

FIG. 6 shows the training process for matrix simplification with non-rated data.

FIG. 7A shows the usage of user recommendations with the social network located on the website that provides the connection between the related users.

FIG. 7B shows the usage of user recommendations with the social network separate from the website that provides the introduction between the related users.

FIG. 8 shows the usage of related users, related social objects and/or likely social objects with social networks.

FIG. 9 shows the architecture for recommendations with affinity cards.

### DETAILED DESCRIPTION OF THE INVENTION

This detailed description is organized to first discuss the novel aspects of the complete system, then describe several novel algorithms that are parts of a recommendation system, and finally several novel usages of a recommendation system.

1. Terminology

Regarding terminology, items include products, items, songs, movies, images, web pages, etc. Users include customers, recipients (such as for email), or anyone browsing or interacting with the web page, website, or any item. Tables, matrices and arrays are used interchangeable. Websites and web pages are not limited to their current implementation, but also refer to information that is available through a network to any device, including computers and mobile phones. Actions include purchases, plays, rentals, ratings, views, or any other usage or action, unless specifically limited. Distributors and dealers are used interchangeably, even though there are differences. Ratings and numeric data are used interchangeably. Categories can have different types, such as product type and brand, and can have different elements, such as shoes, socks, and pants for product types, and Dakine, Columbia, and Nike for brand. The term category usually refers to a category element, but may sometimes refer to a category type. It is clear which definition is used in the context, and the definition is chosen to help ease the complexity of understanding the concept.

2. Novel Recommendation System

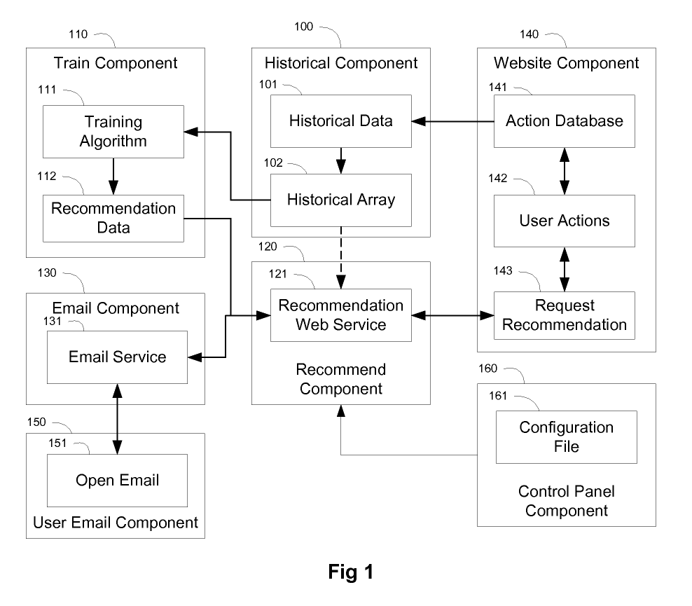

The architecture of the novel recommendation system is shown in FIG. 1. This diagram is the architecture of the system, not computer programs pseudo-code (as described in the implementation subsection below), and used for ease of understanding. The system consists of six main components:
1. Website Component 140: an online location that enables users to act-upon items, and stores these actions in action database 141.
2. Historical Component 100: the process of obtaining the historical data 101 and converting it to the historical array 102 as used in the training component 110 and optionally used in the recommendation component 120
3. Train Component 110: a non-real-time component that converts historical data to recommendation data that is used to efficiently create a recommendation, such as a stand-alone Windows program.
4. Recommend component 120: a real-time component that returns the recommendations to the requestor, such as a Web Service, potentially built in Microsoft .NET.
5. Email Components 130 and 150: a system to provide promotions to the user via email.
6. Control Panel Component 160: a control panel to dynamically modify recommendation touts on the website.

Website Component 140 (Part A)

The website tracks user's actions 142 and stores them in action database 141. This action database 141 provides the input to the train component 110. It includes, at a minimum, user ID and item ID for the action, and optionally includes date, rating, category tag, and item and category names. The category tag may be as simple as use-one or re-use, or include the category of the item, such as clothes, device, supply, etc., where these categories have user-once or re-use inherently associated with them.

Historical Component 100

The historical component is the process of obtaining the historical data 101 and converting it to the historical array 102 that is used in the training component 110 and optionally used in the recommendation component 120. The historical data 101 is either the physical representation of the data as one or more exported files, or the conceptual framework of the links to the action database on the website to the historical array 102. The historical array 102 includes values for non-rated actions and is an element of the training program and optional element of the recommend program.

The historical data 101 is the input to the training algorithm. It can come from several sources. The website's databases usually store user information, item information, and item actions by users. The user information usually includes name, contact information (e.g. address, phone, email), credit card and/or bank information, and preferences. The item database usually includes item name, description, images (various sizes), and price. The item actions database (or databases for a normalized system) usually link an item ID, user ID, date (optional), category (optional) and order ID (optional). The data can be as simple as a rating for a user-item pair ID, or rating for a user ID in a file for the item (or vice versa).

The historical data can come from exporting the user ID, item ID, rating (optional), date (optional), and one or more categories (optional) to one or more files to be used in training and recommendation programs. Alternatively, the historical data 101 can come from directly with the website database 141, such as SQL Server or Oracle, and stored in memory for the program or iteratively called from the database by the program.

Categories can be used to determine if items are use-once or re-use, or to aid in choosing which recommendations to display items to users. For example, the website owner may want to display 2 items in the same category as the currently viewed item, and 1 item in a different category (more details below). Furthermore, the historical data 101 can include returned items, and these can be rated low, or as 0, or used as dislikes (as discussed below in section 6).

The exported historical data can include only recent data, and the previously exported historical data is maintained. Furthermore, exported files can be dropped if they become too old. In this case, the configuration file is updated with the name of the new exported file. Furthermore, iterative training algorithms can train only on the new data rather than all of the data.

The historical data 101's IDs can be alphanumeric, such as SKUs, or numeric, such as primary keys to the database. Thus, in the training and recommendation program, a user index and item index are created which link the alphanumeric ID or sparse numeric IDs (i.e. non-sequential) to a memory efficient, sequential integer index, 0 based for c-source code. The index can use any searchable method. For alphanumeric, the embodiment can use a hash table (preferred since faster) or binary tree arranged by the alphanumeric ID with the index stored in the tree structure for quickly turning the ID to the index for the array access. For numeric, a sparse array from the minimum to maximum ID number is used, storing the index, as it is faster than binary tree at the expense of some wasted memory. For either alphanumeric or numeric IDs, a reverse-lookup array storing the ID for each index is also created to turn the index to the ID. Indexes are used for internal arrays during the training and recommendation algorithms, that don't need to interact with the historical data or item database; thus, access skips the conversion and is direct from the index. The indexes are converted back to IDs for the output recommendations, so they can interact with the user and item databases.

The historical data 101 can also come from links (e.g. scripts, applets or servlets) in the website that send information to a server to track actions (e.g. sales, page views, etc.). The historical data can come from combinations of these, such as the database for sales and the links in the web site for page views. In these cases, the index method discussed above is also used.

No matter how the historical data 101 is obtained, it either includes a rating or action that is converted to a value (as fully described below) and stored in a 1D historical array 102 and indexed by user and item. Alternatively, it is stored in two 2D jagged arrays, one by item index and one by user index, along with a normalized array linking items to categories, or users to categories.

As defined in the terminology section, actions include, but are not limited to, purchases, rentals, playing, viewing and rating. Except for ratings, these actions are non-numeric or non-rated actions. As such, the historic data 101 can be as simple as item ID and user ID pairs in one file, item IDs in a user file, or user ID in an item file, where the entry represents an action. If the action is rated, the rating is included with the ID pair, item ID or user ID, respectively. In other words, the rating is the value shown in the example above.

For non-rated actions, the action is converted to a numeric value and stored in the historic array 102, or represented by an entry in the historic array (e.g. an item and user ID pair inherently represent an action). The goal is that a value of 1 or near 1 can be used, and the resulting estimates represent the probability of action. Obviously, any number can be used and interpreted accordingly. The training algorithms will adapt to the number choices. Using 0 through 1 or 1 through 5 is common as 0-1 has easy probability interpretation and 1-5 has easy rating interpretation. The numbers could be chosen such that 100 could be used and the estimate for non-acted-upon items is interpreted as percent likelihood of action, or such that 0 is the ultimate goal for an action, and then smaller estimates provide more likely actions.

There are numerous methods to convert to a numerical value:
1. Simple Numeric Conversion: One or more actions by a user on an item are represented by a 1, or simply an item and user entry. This case removes repeat actions, and is ideal when repeat actions are very rare, such as buying a book or renting a movie.
2. Repeat Numeric Conversion: The value is the number of actions on the target item and user pair within the historical data. More specifically, the number of actions for each user on the target item is summed over the historical data. This case is ideal for few actions, where each action is important, or for cases where repeat actions are common, such as buying socks or ski wax. This method can be used when the user is a dealer or distributor, and each order already has a number of actions linked to the item and dealer (i.e. user) pair. The resulting recommendation using a numeric algorithm, such as correlation or matrix simplification, estimates the number of actions (e.g. distributor orders).
3. Scaled Numeric Conversion: The value is the number of actions on the target item and user pair within the historical data, scaled by either the total number of actions on the target item, the total number of actions by the target user, the maximum number of actions on the target item by a user, the maximum number of actions by the target user on an item, or the logarithm. The scaling causes the value to be offset, as opposed to proportionally related. This is important in the correlation and matrix simplification methods that use Pearson correlation, since Pearson removes offsets. Most numeric training methods can handle offset (e.g. 1 always rate one higher than you).
4. Mixed Numeric Conversion: One or more actions is represented by the median or slightly above median value of the range of ratings, if non-rated and rated data are combined. For example, with ratings of 1 through 5, the non-rated data is represented by a 3 or 4.
5. Sigmoid Numeric Conversion: The value is the output of a sigmoid or related function with the input dependent upon the number of actions, number of views or both. An exemplar sigmoid function is:

f(x)=x/sqrt(1+x*x), where sqrt is square root. [2.1]

Scaled Case Example with Distributor Historical Data

Distributor data is often ratio based, such as one distributor orders twice as much as another distributor, but the same ratio of products. In this case, it is best to scale the distributor data to remove this multiplicative offset.

One method is to divide each distributor's order data by the maximum ordered for one item summed over the historical period for each distributor. For example, if distributor 1 ordered 50 item A and 200 item B at one date, and then 50 item A and 100 item B at a later date, the maximum order is 300 for item B. Thus, the input for distributor 1 is 0.33(=(50+50)/300 for item A and 1(=(200+100)/300) for item B. If distributor 2 ordered 1000 item A and 3000 item B as summed over the historical orders, the input for distributor 2 is 0.33 for item A and 1 for item B. Thus, the inputs show the similarity between the orders, and can be used with any ratings training algorithm.

Another method is to use logarithms, since they turn multiplication (i.e. ratios) to addition (i.e. offset), and use the output of the logarithm as input. In the case above (e.g. using log base e) for distributor 1, the input to the training algorithm for item A is 4.6 and item B is 5.7, and for distributor 2, the input is 6.9 for item A and 8 for item B. In this case, the offset is 2.3 between distributor 1 and 2, which is handled by many training algorithms via centering and/or Pearson correlation.

Sigmoid Case Examples

Importantly, for the sigmoid or any input function, for 0 the function returns 0 and for large numbers it returns something near 1.

A sigmoid-like function example is as follow, the first purchase is represented by 0.8, and each purchase after that moves the entry 50% closer to 1—such that the second purchase is represented by 0.9, the third by 0.95, and so on.

Items that are purchased, rented or played can also be viewed. A mixture of purchased, rented, played and viewed historical data could be used. An embodiment with the following rules can be used, where entries refer to the user-item pair entry in the historical data:
If the entry is 0, the purchase, rent or play of an item enters a 0.8
If the entry is <0.8, the purchase, rent or play of an item moves the entry to 0.8 (since they bought or played an item that they previously viewed)
If the entry is >0.8, the purchase, rent or play moves the entry 50% closer to one
If the entry is 0, the view of an item enters a 0.2
If the entry is not 0, the view of an item moves it 20% closer to one

In example 1, an item is viewed, bought and then viewed. According to these rules, for example 1, the entry into the historical array 102 is 0.84(=0.2, then 0.8, then 0.8+0.2*0.2). In example 2, an item is viewed; thus the entry is 0.2. In example 3, an item is purchased; thus, the entry is 0.8. The beauty of these rules are that purchases and views don't need to be tracked and then the entry created, as the entry can be updated as new historical action data arrives, assuming the data is in chronological order.

In another embodiment, first apply purchases, rentals or plays as described above, and then apply views with an initial entry of 0.2 if entry is 0, otherwise 20% closer. For the example 1 above, the entry is 0.87(=0.8+0.2*0.2+0.16*.2). For example 2, the entry is 0.2. For example 3, the entry is 0.8.

In even another embodiment, the totals are input to the sigmoid function where each purchase, rental or play is results in a 1 input to the sigmoid, and each view results in a 0.2 input to the sigmoid. Using sigmoid in equation (2.1), for example 1 from above, the entry in the historical data is 0.81(=1.4/sqrt(1+1.4*1.4)). For example 2, the entry is 0.2(=0.2/sqrt(1+0.2*0.2)). For example 3, the entry is 0.7(=1/sqrt(1+1*1).

More Possibilities

Items can be tagged as re-use for items a user may continually buy, e.g. light bulbs, or interact with, e.g. songs. Alternatively items can be tagged as use-once for items that a user will most likely buy once, e.g. a couch, or interact with once, e.g. movie rental—although with gifts and long-time users, use-once items can be bought a few times. In this case, re-use items use the entries that approach 1 described above, and use-once use a 1 for an entry when acted upon.

For some actions, such as playing a song, items are inherently market re-use (or re-play, in this case). For example, playing a streaming song or video, such as a rental, or playing a song or video on a PC jukebox or in an advertised supported web site, such as Pandora.com, results in a value at or near 1 in the historical played data matrix. The preference is to have the input move towards 1 as viewed items are most related to items tagged as re-use.

For viewed items, any of the options described above are applicable when only viewed items are represented in the historical data. For example, viewing an item's web page results in an entry at or near 1 in the historical viewed data matrix. Similarly, playing some or all of an audio and/or video (A/V) item as a sample to determine if the user should purchase the item (considered viewing not playing), results in an entry at or near 1 in the historical viewed data matrix. The A/V item can be part of a song or item that is purchased, or sales material for an item.

Finally, if a non-rated algorithm, such as correlation, is used with rated data, the ratings can all be turned to actions, or only positive ratings, such as 3, 4 or 5. In the latter case, items that are rated 1 or 2 are not included as acted-upon items, thus, not included in the correlation calculation. Ignoring these items can increase accuracy (similar to removing actions on returned items).

Train Component 110

In the preferred embodiment, the train component is a windows program that can be run from a graphical user interface (GUI) or command-line input for automated usage. Training is run periodically, from once an hour, to once a week. The recommendations don't change between training, so the period between re-training is a trade-off of updated recommendation versus computation processing. The training takes a minutes to thirty minutes for 10M historical action entries using the training algorithms discussed in this application, and less time for fewer historical entries.

The input is a configuration file. The file includes the one or more filenames for the historical data 101. The more historical data used in training, the more accurate the recommendations. However, if there's been a recent shift in users or items, the client may want to train only from that time period. For most clients, a year window is suggested as most products have a six month lifecycle, corresponding to summer and winter.

The training algorithm 111 is the core of the training component. Several training algorithms are discussed later in this application. Some work better with rated data, and others work with non-rated (e.g. played, purchased, rented, viewed, but not rated) data.

In a preferred embodiment, the training algorithm is dynamically chosen based upon the amount of rated data. For example, if half of the data is rated, then the training algorithm that is best for rated data is chosen. If one-eighth is rated, then the training algorithm that is best for non-rated data is chosen. It is expected that the threshold is around ¼ of the data being rated, such that, if less is rated, the non-rated algorithm is used, and, if more is rated, the rated algorithm is used. If the data does not have a field that lets the algorithm know if the data has been rated or not, then the standard deviation can be used. If the threshold is ¼ of the data, ratings are 1-5, and non-rated data is represented as a 3 or 4, then a SD of between 0.5 and 1 is a good choice for the threshold.

In another preferred method, the training algorithm is a combination of correlation and matrix simplification methods, such as half the likelihood from each method. This is preferred since correlation methods trend towards items that are acted-upon often (i.e. popular items), as these items show up in related items often. In contrast, matrix simplification methods trend towards an item that may not be acted-upon often, but obtained excellent rating from all of the few users. As such, the average likelihood value will include the number of actions upon an item, and its average rating. The preferred embodiment with rated data is to use correlation with items that received good ratings (e.g. 3 or above for 1 to 5 ratings where 5 is best), use matrix simplification on all of the rated data, and then combine. However, rated based correlation methods can be used, especially with non-parametric correlations or similarities. For non-rated data, non-rated correlation and matrix simplification methods are used.

Out of stock items are removed during training. The out of stock can be sent to the training via a file with item IDs that are out of stock. The training also lets the web service know that new recommendation files are available via an UpdateRecTables( ) call to the web service.

The output of the training algorithm is the recommendation data 112 used by the recommend web service 121 and email service 131.

Recommendation Data 112

The recommendation data 112 can be an estimate of the rating or likelihood of action for that item by that user.

In addition or alternatively, the recommendation data 112 can be a table of similar, related or likely items and users, as follows:
1. Similar Items—Table with a target item ID followed with a list of 10-20 item IDs of products that are similar to the target item.
2. Related items (Cross-Sell Items)—Tables for item-to-item, categorical, and similar-to-related items. Each table has a target item ID followed with a list of 10-20 similar item IDs and similarities that are most related to the target item. The table can include each target item ID or only target item IDs with a minimal number of actions. The related items are also called cross-sell items because they are sold with the target item.
3. Likely Items (Up-Sell Items)—Table with a target user ID followed with a list of 10-20 item IDs and likelihoods for item IDs that the target user is most likely to act-upon. The table can include each target user ID or only target user IDs with a minimal number of actions. The table can further include 1-5 why items for each likely item. Likely items are also labeled as up-sell items because these suggestions can be used to convince the user to act upon another item unrelated to their immediate actions (but dependent upon previous actions, such as buying habits). The table can combine likely items using item-to-item, categorical and similar-to-related items, or have separate tables for each method.
4. Related Users—Table with a target user ID followed with a list of 10-20 user ID, similarity pairs for other users that are most related to the target user. The table can include each target user ID or only target user IDs with a minimal number of actions. The table can include users that act upon the same items and same categories, or have different tables, one for related users based upon items, and one for related users based upon categories.
5. Likely Users—Table with a target item ID followed with a list of 10-20 user ID, likelihood pairs for user IDs that are most likely to act-upon the target item. The table can include each target item ID or only target item IDs with a minimal number of actions. The table can further include a few why users for each likely user.

These tables are combined with an item details file that link item IDs to category IDs and item names, along with files that link category IDs to category names. Categories are preferably product type and brand.

Furthermore, the correlation between related items or users is known as similarities, and the summed correlation between a likely item and user or likely user and item is known as likelihoods.

Similar Items

Similar items can be found via several methods, and combining the results of each method is optimal.

In the first method, the top selling items that are in each of the target item's categories are similar items. In the preferred embodiment, the brand and product type are used. If not enough of these items exists, then the top selling items in one of the categories of the target item, and finally top selling items in any category are used.

The similar items are preferably listed in a file containing each item ID and then a list of similar items. However, they could also be listed for each category combination and then obtained from the item's categories. Alternatively, they could be created by the web service from multiple files with top sell items for each category, although each file would have to have numerous, like 300, top sell items for each category so that items that are in multiple categories can be found. The preferred implementation is to first store the N (like 10-20) top selling items for each brand and product type combination in an array. The array size is the number of brands times the number of product types. Then, based upon the target item's brand and type, move the N top selling items for that brand and type to a file indexed by item ID, removing the target item if it exists in the recommendations. Importantly, one more item than the final number of recommendations needs to be stored in the category array since the item may be the target item and needs to be removed for the target item's similar recommendations.

Another method to find similar items is discussed in the Brute Force subsection and subsequent Clustering subsection below. These are two methods to find similar items as items that are not related to each other, but related to the same item. Even another method is to use view data and find items that are viewed by the same user, in the same fashion that related items are found using action data.

Optimally, similar item recommendations include items from all three of these methods. This is optimal since the first method provides top selling items, which are likely to be purchased since they are top sellers. However, the latter two methods can suggest items that are not popular, and provide sales of numerous non-popular items. This latter affect, known as the long tail, is critical to e-commerce since a website can have a large, international user base and huge inventory, such that numerous non-popular items, each being bought by a few users, is as profitable as a few popular items, each being bought by numerous users. Having popular items is critical for a physical store, since it has a fixed inventory space and limited customer base.

Related Items (a.k.a. Item-to-Item Related Items)

In summary, with extra details described in the following sections for different types of training algorithms or in other prior art, the related items and related users are direct outputs of correlation based techniques. For matrix simplification techniques, they can be determined by correlating the item features or user features. Furthermore, the price or price minus cost-of-goods sold (COGS) can be used, such as multiplied by the similarity, to weight recommendations by revenue or profits.

Categorical Related Items (or Users)—a.k.a. Genomic Training

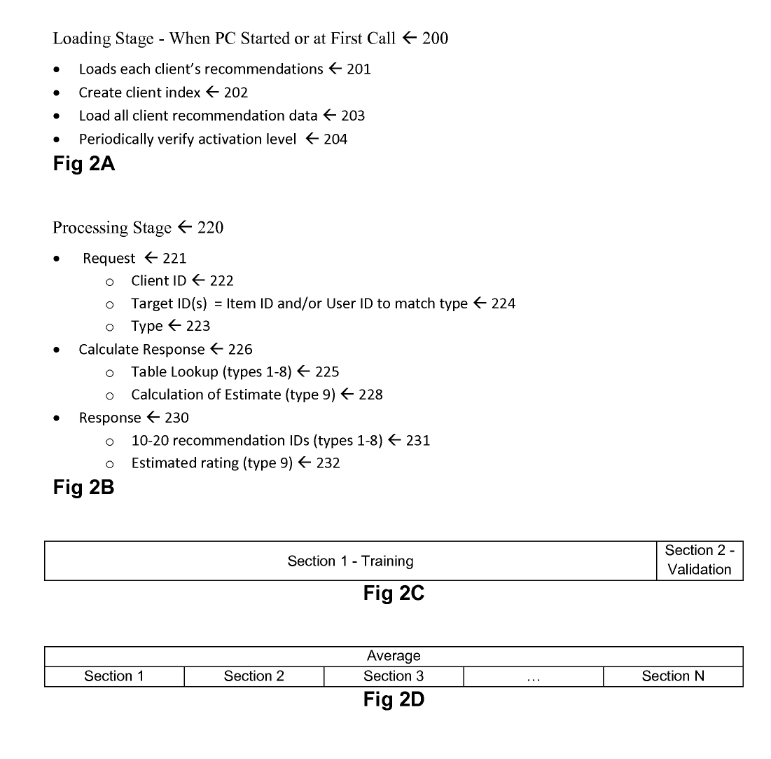

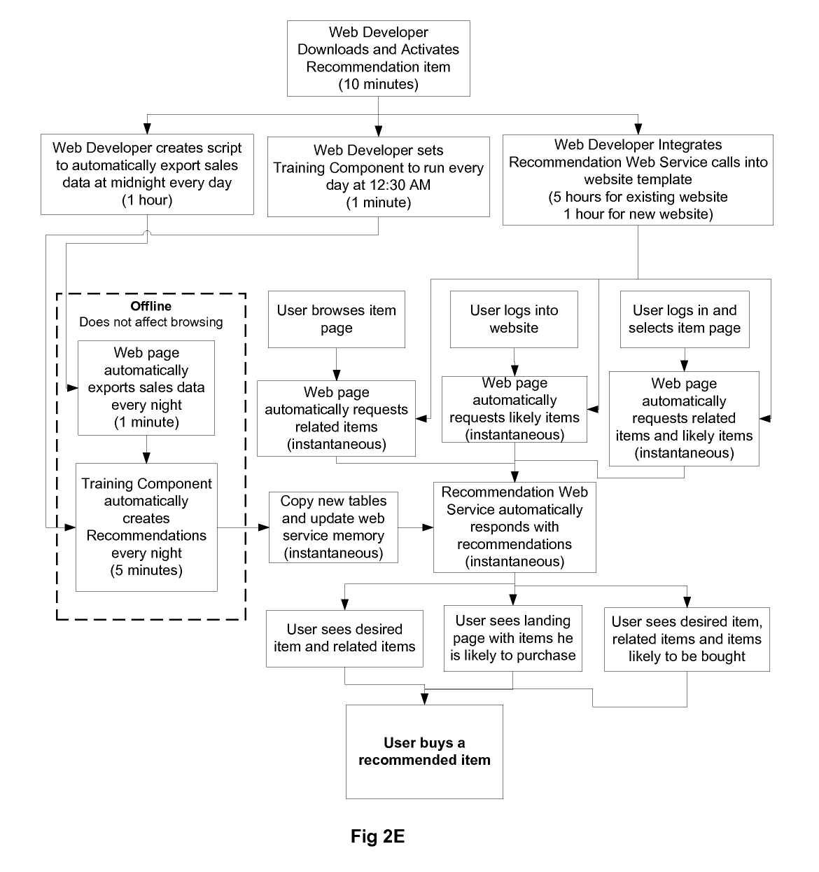

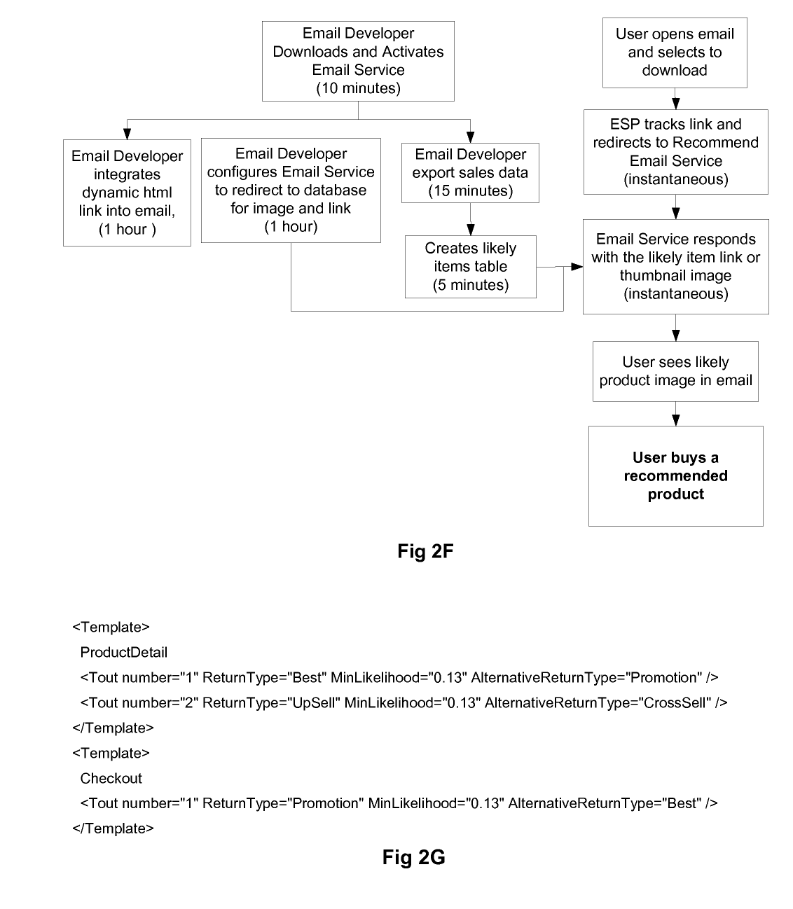

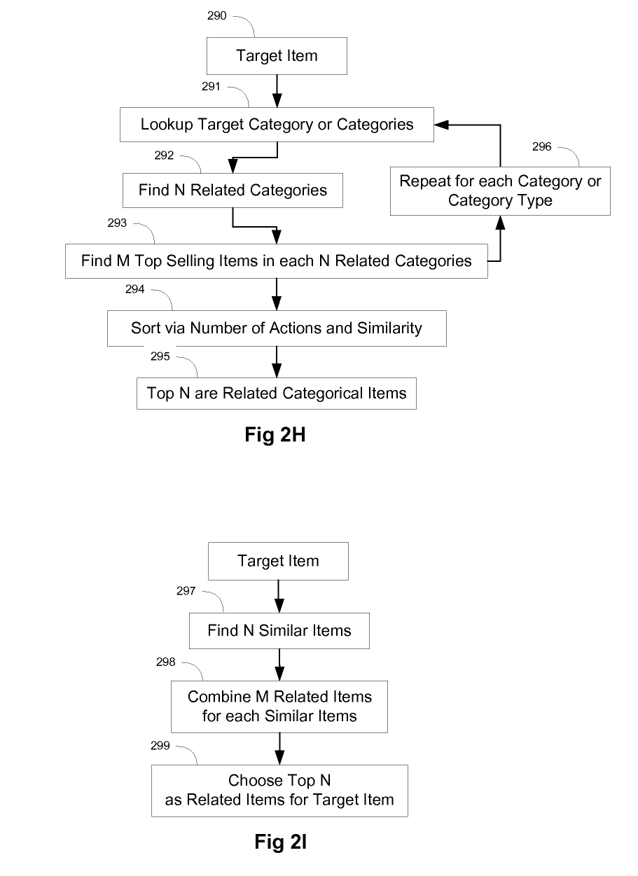

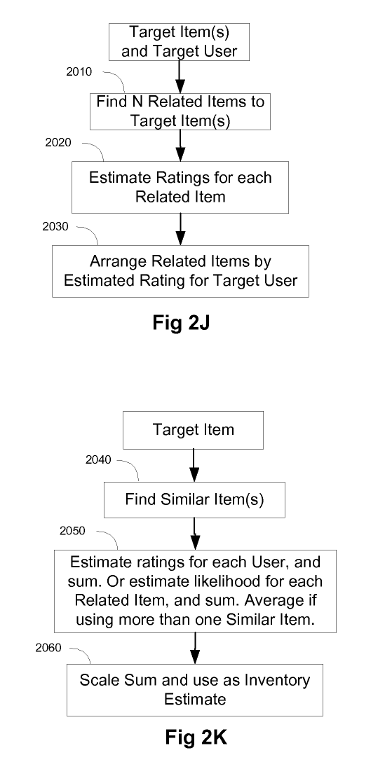

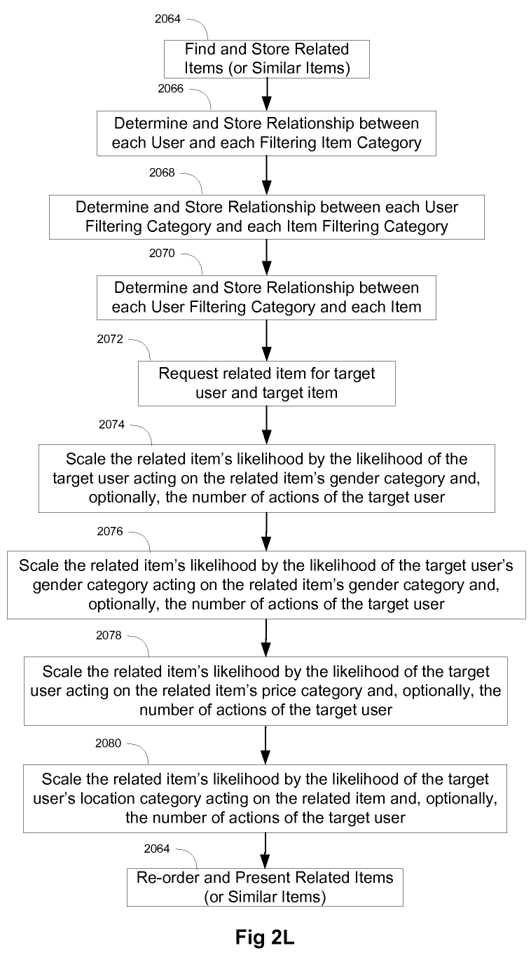

As shown in FIG. 2H, for categorical related items, the training algorithm uses categories. The category types are related to the item and/or user, and can include brand, product type, genre, gender, demographics, color, etc. Categories are optimally 1-1 with items, but each item may have several categories, such as a gender-free shirt belonging to men's shirts and women's shirts. If the categories are hierarchical, like clothes and clothes/shirt, it's best to chose one, usually the most detailed category. The advantages are that this method provides recommendations if there are few actions, and enables promotions for new and existing items to be more accurately recommended. This step is optional if the client has enough actions, such as for items with long life-cycles, such as books, movies, audio, and furniture. The algorithm trains on category actions, where category actions are determined from item actions, where items belong to a category. Then, the client can use item-to-item related items, or, if there are not enough related items for recommendations above a minimum threshold for similarity (and/or with a minimum common number of users, such as 2 or more), these categorical related items are used. These categorical recommendations can be placed in the related items table in the training tool, or placed in a separate categorical related items table and intelligently combined with related items by the web service.

The process is as follows. For a target item 290, lookup the category (or categories) of the target item (step 291), labeled target category (or categories), find N (like 10-20) related categories to the target category (or for each target category) (step 292), find M (like 10-20) top sellers in each related category (step 293), and sort the top sellers based upon the number of actions and category similarity (294), and finally recommend the best top sellers. The categorical related item is compared to the existing related items to make sure that it is neither the target item nor a previous recommendation. The step is necessary because a top seller may have already been recommended from another category, if categories are not 1-1, or the target item is a top seller in a related category (such as the target category). When keeping categorical related items as its own table, an advantage is that the recommendation web service can be set by the client to recommend categorical items. Preferably, the effect of number of actions of the related and target items are reduced using the logarithm, and effect of category similarity is enhanced by squaring the similarities, which are less than one. Thus, the similarity of the target and related items, also known as likelihood (of action) is the log of the square root of the number of related items actions times the target item actions, times the similarity squared, as shown in equation 3.3.

When there are multiple categories for each item, the number of times that item is acted upon in each pair in the multiple categories is stored, and the effect removed when calculating similarity between categories using equation 3.1. This is important so that categories that contain the same item don't appear as related categories due to the same item, and not that a user that bought a different item in each category. The implementation is described in section 3.

Preferably, two category types are used, product type and brand. The similarity of the target item's product type with the related product type and the similarity of the target item's brand with the related brand are both used to sort the items. As shown in equation 3.4, the likelihood is the log of the square root of the multiplication of the number of actions of the related and target item times each similarity. With a computer implementation, this process includes two main steps and two sub-steps in each main step. The first main step uses N related product types. The first sub-step is to find all top sellers of related product types (as described above and in steps 291 to 293). The second sub-step is to find the brand similarity of each top seller. The second sub-step preferably only searches a limited number, like 60, of brand similarities, and if not included in this list, is assumed to be 0. The second main step uses N related brands. The first sub-step is to find all top sellers of related brands (as described above and in steps 291 to 293). The second sub-step is to find the product type similarity of each top seller. The second sub-step preferably only searches a limited number, like 60, of product type similarities, and if not included in this list, is assumed to be 0.

One method of calculating similarity between categories is described in detail in the Categorical Training subsection of section 3. Most importantly, repeat actions in each category must be included since each category, which includes numerous items, will often have numerous actions by each user. Alternatively, the determination of related categories could be based upon the numeric correlation or matrix simplification methods by turning actions into numerical values via the repeat or, preferably, scaled numeric conversion, as described above.

More specifically, product type includes shoes, socks, clothing, bathing suits, snow board, furniture, books, computers, hardware, etc. Product types can be one of several hierarchical layers, such as layer 1 is men's clothing, women's clothing, equipment and layer 2 is shoes, socks, pants, snowboards, computers, etc. The preference is to use the lowest level category, i.e. the category with the fewest items, since if there are too many items it will be hard to find a good similarity between categories.

From this description, it is easy for someone familiar to the state of the art to see how this process can be extended to any number of category types (like product type, brand, size, color, etc.), or any number of categories linked to one product (like men's shirts, women's shirts, and exercise shirts linked to a gender neutral breathable shirt).

Importantly, promotions can be given a base action level (i.e. weight) so they are intelligently integrated via categorical recommendations. The promotions can be new or existing items.

Alternatively, related users can be found by using categorically related items. In sparse data, especially for midsized online retailers, it is unlikely that users have acted upon the same items. In addition, users may not have categories. However, users have more likely acted upon different items with the same category. As such, related users can be found using the category of the item, rather than the item itself. The training is the same as for related users using items, except that the item is replaced with the item category.

Filtering Categories

In a similar fashion that categories are used to find related items, categories can be used to filter recommendations for the target user. This is best understood through examples. In example 1, if the target user has only bought items for men, then related items that are for women are lowered in likelihood and/or men's items' likelihoods are raised. In example 2, if the target user only acted upon items in the lowest price range, similar items that are expensive are lowered in likelihood and/or inexpensive item's likelihood are raised.

Furthermore, if the target user does not have enough actions, the user's categories are used. Example 3 is based upon the first example, but rather than using the target user's purchases, it is known that the target user is male, and the categorical relationship between male users and men or women items, show that males mainly act on men's items, related items for men are raised and/or related items for women are lowered. Interestingly, it may be found that female target users act upon both men's and women's items (and even children's or boys and girl categories). In example 4, if the target user's location is known, products that have been shown to sell to that location have their likelihood raised and one's selling elsewhere are lowered. The location can be measured in terms of GPS coordinates, zip code, or first three digits of the zip code (broader area than all five digits).

These examples show the three different types of filtering categories methods:

1. Target user is related to item category (example 1 and 2)

2. Target user category is related to item's category (example 3)

3. Target user category is related to item (example 4)

The preferred embodiment has gender and price category types for products, and gender and location category types for users. The price category is broken into groupings as discussed below in the Continuous Categories subsection, in section 2. However, any category types and any number of categories can be used, given the steps below. In addition, the categories used in genomic training can be the same category used for filtering. In the preferred embodiment, price is used in genomic training and filtering.

As shown in FIG. 2L, the general training method (i.e. creating of recommendations) involves the following steps. It is preferable to store the results in an offline training process as discussed in the steps, but not critical. This process is described for related items, but also works for similar items, top sellers, and any recommendations.
1. In the offline training process
   a. Find related items (or similar items) and save the top 20 or so, using any method, where the items have gender and price categories and the users have gender and location categories.
   b. Determine relationship between each user and both item categories and save the likelihood value of both item categories for each user, along with the number of user actions in each item category—using any method. The item category is determined from the item in each action (noting that an action includes a user and item pair—in other words, users act on an item).
   c. Determine relationship between each user category and item category for each action, and save the likelihood value for each combination (e.g. 4 when items and users have 2 categories each)—using any method. The user category is determined from the user and the item category is determined from the item in the action.
   d. Determine relationship between each item and both user categories, and save the likelihood for both user categories for each item, along with the number of item actions in user category—using any method. The user category is determined from the user in the action.
2. When requesting a recommendation for a target item, and the target user is also known, obtain the 20 or so related items, sorted in order by the likelihood of action with the target item, adjust the likelihood and, thus, the sort order in the following fashion:
   a. If the target user has more than a threshold number of actions, multiply the related item's likelihood times the likelihood that the target user acts on the related item's gender category times 2, and limiting the maximum likelihood to 80% or 0.8.
   b. If the target user has less than a threshold number of actions, multiply the related item's likelihood times the likelihood that the target user's gender acts on the related item's gender category times 2, and limiting the maximum likelihood to 80% or 0.8.
   c. If the target user has more than a threshold number of actions, multiply the related item's likelihood times the likelihood (Lc) that the target user acts on the related item's price category times 2, and limiting the maximum likelihood to 80% or 0.8.
   d. If the target user's location category has more than a threshold number of actions, multiply the related item's likelihood (Ld) times the likelihood that the target user's location category acts on the related item time 2, and limiting the maximum likelihood to 80% or 0.8.
   e. Re-order the related items by the scaled likelihoods, and present to the target user in the update order, or only present the top 3 or 5 of the 20.

A preferred method to calculate the likelihood that a target user or user category acts upon an item or item category is described below in section 3, Filtering Categories, and is based upon the percentage of total actions from the target user or user category.

Preferably, the threshold number of actions can be a constant number, like 5 or 10 actions, or derived from the average number of user actions, but also greater than a minimum threshold, like 10. The threshold can be used to scale the results, if the target user's number of actions are less than the threshold. The weight of the steps can be scaled by the number of target user's action, N, such that the effect is larger or more significant with more actions. Since steps 2a and 2b are inter-related, the scaling factor could be the result of 2a times N/10 and value in 2b times (10−N)/10, only when N is less than 10. Similarly, the scaling factor could by N/(10+N) for step 2a and 10/(10+N) for step 2b, for any N. Steps 2c can replace the likelihood (Lc) with the following equation: L=0.5*(10−N)/10+Lc*N/10. The same can be done for step 2d.

The factor of 2 is preferable since it raises the likelihood a little when filtering categories match (i.e. greater than 50% similar), and lower a little when not (i.e. lower than 50% similar), since this matches expected behavior. For example, if the likelihood for all users to act upon something is 15%, but most are men, if the likelihood was determined for men only, the likelihood may be 20% or 25%. If it was determined for women only, it may be 5% to 10%.

Similar Items to Related Items

Furthermore, items that are similar to the target item can be used to determine related items. Several methods to determine similar items are discussed in the Similar Items subsection above, and any of these or other methods can be used. As shown in FIG. 2I, N (like 10-20) items similar to the target item are found in step 298. The M (like 60 to 100) items related to each of the N similar items are combined, where duplicates are summed and then fed through a sigmoid after every recommendation is combined. The top N combined results are kept as similar to related items, as shown in step 299. Obviously, the number of similar items and similar to related items does not have to be equal, but 10 to 20 is preferred as the number of recommendations to save.

Likely Items and Users

In correlation-based techniques with non-rated data, the following steps find likely items for a target user. For each item acted-upon by the target user, the similarity with N related items are added to a list, and if the related item already exists in the list, the similarity is summed. The potential likely items with the K largest summed similarities are the likely items, and the summed similarity is scaled and used as the likelihood. In the preferred computer implementation, the list includes every item, each item is reset to 0, and the N similarities are added in the correct indexed location. The N related items can include all items with a minimal similarity, such as 0.1, or 60 to 100 most related items. Before the summing each N related item, each acted-upon item, if tagged use-once, can have its summed similarity greatly reduced, such that the acted-upon item cannot be a likely item even if it shows up as related items to other acted-upon items for the target user. This is more efficient than checking the likely item list with the historical data.

To determine likely users for a target item, for each user that acted-upon the target item, the similarity with N related users are added to a list, and if the related user already exists in the list the similarity is summed, and stored with each user (i.e. potential likely users). The potential likely users with the K largest similarities are the likely users with the sum scaled and labeled likelihood. The implementation details are similar to likely items, with the role of item and user reversed. The N related users can include all users with a minimal similarity, such as 0.1, or 60 to 100 most related users. Each user that acted-upon the target item can have its summed similarity greatly reduced for use-once target items, so that user does not become a likely user.

Alternatively, to find the likely users for a target item, numerous related items, such as 200 to 500 related items, are found, and then users who acted upon each related item are determined. If a user acted upon several related items, their likelihood value increases by one for each action. If the item is not to be resold, users that also acted upon the target item are removed from the list (i.e. likelihood value greatly reduced). This method is advantageous since it does not require calculating user-to-user similarities, which are very time consuming since there are usually many more users than items. In addition, for promoting an item, such as through email, the goal is to find is to find hundreds to thousands of likely users.

For the methods of finding likely items and likely users, all of the acted-upon items or users can be used, only the last N, like 30 to 50, or last 6 months of actions can be used. Using the last N acted-upon items is preferred since it is consistent across various items or uses, independent of recent activity. The dates don't have to be exported in the historical data 101, as the historical data 101 only needs to be in chronological (or reverse chronological) order, so that the most recent actions are identified as the last actions (or first actions).

Furthermore, the resulting likelihoods aren't between 0 and 1, and need to be normalized. The goal is to have likelihoods that match related items so that the recommendation web service can choose whether a related item or likely item is best (as well as categorical related item or likely categorical item, as discussed below). The logic to the method is based upon a couple hypotheses. First, an item that the user is viewing is slightly more likely to be acted upon than a likely item that is based upon action history. As such, the normalization equation lowers the likelihood, and a factor of 0.8 is used as the max likelihood along with a sigmoid. Second, if a likely item A is based upon three acted upon items, each with 30% similarity with the likely item, or likely item B is based upon six acted upon items, each with 15% similarity with the likely item, it is believed that likely item A is more likely to be acted upon than likely item B since the user has a stronger affinity with items related to item A. As such, the normalization equation uses the maximum likelihood or average of top few acted upon items as a lower bound. Third, the number of total actions by the target user implicitly affects likelihood, since it increases the likelihood by providing more acted upon items, which matches the fact that a user with more actions is more likely to act again. Thus, it does not need to be part of the normalization equation.

The normalization likelihood equation is as follows: use most related acted upon item (Largest=largest why item), or average of top few acted upon items, add remaining summed similarities (Sum) with sigmoid, then scale each result by the summed similarity (Sum) divided by the maximum summed similarity (SumMax), where the sum is the value before passing through the sigmoid, as shown in equation

Normalized=Sum/SumMax*(Largest+(0.8 F−Largest)*(Sum−Largest)/(1+Sum−Largest)) [2.2]

In correlation-based techniques with rated-data and matrix factorization techniques, the estimated ratings for user-item pairs are used to find the likely items and likely users. However, these recommendations based upon estimates could use related items and users to create likely items and users, as done in the previous paragraph.

Why Items and Why Users

For each likely item, it is advantageous to display to the user why this likely item is chosen, labeled why items. This helps the user understand why likely items are displayed and select a likely item with more information than just the likelihood value. In simple terms, the why items are the items that the user previously acted upon that are most related to that likely item—limited to the same period as used to determine likely items. Equivalently, the why items are the acted-upon items that contributed the most to determining that likely item.

The why items are saved during training into the likely items table, such that table is user ID, likely item 1 ID, likelihood1, why item 1 ID, why item 2 ID, likely item 2 ID, likelihood 2, why item 1 ID, why item 2 ID, Alternatively, a separate file could be used for why items, and the likely item table is synchronized with the likely items table.

There are two methods to calculate why a likely item is displayed, labeled why items, which can be displayed to the target user.

The first method works for correlation and matrix simplification methods, for rated or non-rated data. In this method, after creating a likely item list and related item list (by any method), for a likely item, the 1-to-5 acted-upon items (by the target user) with the largest similarities are selected as why items. This is repeated for each likely item.

The second method works for techniques that create likely items via summing similarities of related items with acted-upon items, rather than estimating a rating for each item and choosing the largest estimated item ratings for a user as likely items. This is always done with correlations methods with non-rated data, and can be done with matrix simplification with rated or non-rated data and correlation with rated data.

In this second method, while creating the potential likely item list for a target user, a second potential why item list is kept. The list is of length equal to the total number of items (i.e. potential likely items), and each element is a structure for potential why items, including one to three entries for an item ID and similarity. Each time a potential likely item and acted-upon item has a similarity added to the potential likely item's total, the similarity is compared to the smallest potential why item, and if larger, the acted-upon item is inserted in the potential why item list for that potential likely item. This method is advantageous to method one since it occurs simultaneously. However, it uses more memory since it needs to track why items for all potential likely items, not just the final K likely items. The system also needs to synchronize potential why items as potential likely items are properly placed in the list of likely items—in other words, if the potential likely item moves to first place in the likely item table, the corresponding potential why item needs to be placed in first place in the why item table.

Equivalently, items can be replaced by users, and why users could be created and associated with likely users of an item.

Categorical Likely Items

Categorical related items can be used to determine categorical likely items. In one method, the top 60 to 100 categorical related items for each item acted upon by the target user are combined, and repeat items have the similarity summed. In a second method, the category of each acted upon item is determined, the N (10-20) related categories found, and the M (10-20) top sellers in each related category are combined, resulting in 100-400 potential categorical related items for each acted upon item, with calculated similarities (preferably using logs and squares as described above and in section 3) summed for repeat items. For either method, the resulting items with the largest similarities are the likely categorical items. Then, the likely categorical items are added to the end of the likely items list, if needed. They could be used to create a likely categorical item table, but it is not expected that a client would specifically want a categorical likely item over a likely item.

The why categorical items are calculated in the same fashion as why items are for likely items, saving the top few acted upon items with the highest similarity to the categorical related item recommendation. In any of these methods, if the user acted upon an item multiple times, it is optional to multiply the resulting similarities by the number of actions to scale the affect. Furthermore, the final likelihoods are scaled, such as with a sigmoid, as discussed in detail earlier in this section.

Furthermore, the final recommendations can be created by combining the likelihood estimate and rules, such as the most likely items in three categories are used. More specifically, let's assume the target item is a hat, and, in order of largest likelihoods, the first three are hats, next two are t-shirts, and final one is a sock. If the client asks for three recommendations, three hats would be returned if using likelihood only. However, if the rule is that up three categories should be returned, the first hat, the first t-shirt and the sock would be returned. This has benefits of providing the user with broad recommendations. In other words, the ranking of recommendations is dependent upon the likelihood value and previous recommendations.

Equivalently, for user categories, such as demographics, this process can be performed to determine categorical related users and likely categorical users.

Recommendations with No Actions and Dirty Data

For a category with few selling items, a categorical similar item and categorical related item can be an items with no actions. As such, in the computer implementation, the storage must not reject items with 0 actions and differentiate ‘no item’ from an item with no actions. The preferred implementation for similar items initializes actions to −1 such that 0 actions are stored and identifiable (especially since 0 is a valid item ID and index). For categorical related items, items with no actions have a small number, like 0.01, added to their number of actions, and then the final likelihoods that are above 0 but below the storage value, e.g. 0.001 if three decimal places are stored, are set to 0.001 so they are stored and identifiable.

Furthermore, data is not always perfect. Many times there is an item that occurs more than once in the data base with different IDs. As such, items with the same name, brand and at least one identical category are grouped. For the items in the group, all of the linked categories do not need to be the same since the dirty data often occurs because the item is re-entered in a different category. The actions on this group are treated together, and then the recommendations for group apply to every item in the group. The recommendations are still stored for each item's ID in the group—such that the web service does not have to use the group lookup table. For categorical training, the actions on any item in the group are also included in every category across the items in the group, even if the category is not linked to each item in the group.

In the computer implementation, the group is created on the item details file, which links the item ID to its categories IDs, before any processing such that a new item details file is used by the training. The new file includes the list of all item IDs included in this group, with the item ID of the group being the first item ID of the group's items (lowest if saved in increasing ID order). This means that if there are no duplicates, the two item details files are the same. The group file is then used to write the group recommendations for each item in the group in the recommendation tables or files.

Top Sellers and Promotions

Preferably, top items, promotions and top users are included as three separate tables. For top items and promotions, if a category is included, the table can have the top items across all categories, and then the top sellers within each category. The promotion can be given a pre-determined number of sales, i.e. weight, and category so it can be properly integrated as a best recommendation, or it can be forced to be listed in a recommendation tout.

Alternatively, the tables can include default entries for top items or promotions. For example, the top selling items can be included in likely items table as customer ID of −1, or any unlikely customer ID, and in the related items table as product ID of −1, blank, or any invalid product ID. If the client is promoting an item, it can be entered into the likely items table, manually or via a promotion tool, as customer ID of −2, and in the related items table as product ID of −2, or any unlikely ID that is different than the top sellers ID. Equivalently, a default list of likely-users can be created as the most active users in a specific time period, and it is returned for a null item ID when likely users are requested.

Training Validation

It is beneficial if the train component can validate itself as accurate, and can adapt to increase accuracy.

Cross validation techniques can be used, where first section of the data is used for the training algorithm, and then the second section is used to validate, as shown in FIG. 2C. Usually, the first section is larger and contains earlier actions. The data can be chronologically ordered if date is provided or inherently included in the action order (e.g. the historical data goes from oldest actions to newest actions). For non-numeric data, one validation technique is as follows: determine likely items for a target user for the first section, and then monitor the likelihoods of items acted upon by the target user in the second section. If, in the second section, the average likelihood is low, such as below 0.33 for a likelihood system normalized to the most likely item as 1, there's a potential issue. In a simple method, the top 40-100 likely items are found, and if more than ⅔^{rd} of the actions are not in that list, there's a potential issue.

For ratings data, the verification can use the first section to estimate ratings for items acted upon in the second section, and the error is used to determine if there's an issue. For example, if there's a root mean squared error (RMSE) for the estimates above 12.5% of the RMSE using the item average, there's a potential issue.

For potential issues, the client can be notified, or the train component can try again removing a portion of the older data. If these latter results are accurate, these results are used, and if not, the client is notified or training is tried again with another portion of older data removed. There is a maximum of retries allowed before notifying the client, and this number is dependent upon the amount of data removed.

Another validation method is to divide the data into two or more sections, preferably arranged by action date, and then train on each section, as shown in FIG. 2D. The related and likely tables of each section are compared, and if very different, there's a potential issue. For related items or users, and two equal sections of data, the comparison sums the difference in similarity between the top 10 related items or users for the first section, and if this sum is above a predetermined threshold, such as 20% when similarity is between 0 and 100%, there's a potential issue. For likely items or users, the comparison sums the difference in likelihood between the top 10 likely items or users for the first section, and if this sum is above a predetermined threshold, such as 0.3 when the likelihood is between 0 and 1, there's a potential issue

If multiple sections are use, the comparison can be done one by one, or from the average of all of the sections with each section.

When there's a potential issue, the train component 110 can let the client know there's an issue, or automatically ignore sections with older data. If the validation uses multiple sections, and sections with an issue are not based upon date, but dispersed over time (e.g. bad section, good, good, bad, good, bad—rather than bad, bad, good, good, good, good), it is best to notify the client rather than ignore bad sections. When bad sections are ignored, either the training occurs again using only the data from good sections—or the average of the good sections are used without retraining.

Recommend Component 120

In the preferred embodiment, the recommend component 120 includes a recommendation web service 121. It is called in one of several types:
1. Best—Given one or more target item IDs and/or user ID, return item IDs that are the best recommendations.
2. Similar Items—Given one or more target item IDs, return the most similar item IDs.
3. Related Items—Given one or more target item IDs, return the most related item IDs.
4. Intelligent Related Items—Given one or more target item IDs, return the most categorical or similar-to-related item IDs.
5. Likely items/Up-Sell—Give a target user ID, return the item IDs that the target user will most likely act-upon.
6. Related users—Given one or more target user IDs, return the most related user IDs.
7. Likely users—Give a target item ID, return the users IDs that will most likely act on the target item.
8. Top Sellers—Given a target item ID, return item IDs that are top sellers in the target item's categories. If no categories are included or no item ID, return item IDs that are top sellers for all historical sales.
9. Promotions—Return promoted item IDs.
10. Estimate—Given a target user ID and target item ID, return the estimated rating

The inputs are the type (i.e. 1 through 10 for types listed above), client ID, and user ID, item ID or both. The type is not necessary if different web service calls for each type are created, such as a SimilarItems call and a LikelyItems call. The client ID enables the web service to run multiple clients on one server, and matches the name of the configuration file used in the train component 110. An alternative approach is to have a unique web service for each client. However, it is preferred, and less expensive, to have one web service, with one name, that runs multiple clients—in the range of 10-100 clients on one computer as discussed in the memory section below.

The inputs can also include number of recommendations to return, return format (e.g. XML, plain text or tab separated), position, minimum relationship and minimum common. The position is the starting point in the recommendations and enables the client to get different recommendations with the same input user and/or item IDs. The minimum relationship includes the minimum similarity or likelihood, below which the results are considered unreliable. The minimum common is the number of common users between items below which the results are unreliable (usually for correlation based techniques, but can also be applied to any technique). These variables can be dynamically set in the control panel 160 discussed below.

For types 1-9, the output is a list of recommended item or user IDs with a value that is based upon the training method, such as cosine similarity, and recommendation type, such as number of purchases for top sellers or pre-determined weight for recommendations. These items have the highest value of all items. In the preferred embodiment, 10-20 recommendations are provided so that a few of them can be used in the variety of fashions as described above—or the number of recommendations requested as an input parameter. The lookup is instantaneous since it's a simple table lookup.

For type 10, the output is an estimate. For matrix simplification, it requires 40 to 80 multiplications and additions. For correlation techniques, it is more complex, requiring millions of comparisons to create the neighborhood and then 40 or so multiplications and additions for the estimate. However, given processor speeds, this is still requires less than a second, assuming the weights are stored in memory.

When both the user ID and item ID are included, results can be checked against the historical data 101 to remove items acted-upon by that user, or users that have already acted-upon that item. Additionally, out of stock items can be removed at this point, if not removed at training and no new items have sold out since training.

The architecture is shown in FIGS. 2A and 2B for types 1-4. The loading stage 200 includes loading the web service, preferably when the PC starts, and all of the recommendation tables. If built on Microsoft .NET, it loads when Windows starts, either by loading it via registry entry or loading a program that calls it via the registry, and then .NET retains the web service in memory. When loaded, the web service uses a clients list, usually linked to security licenses, or searches the folders in a specific data path, to find all the client recommendation files—including any combination of similar items, related items, related users, likely items and likely users—and loads them into memory (steps 201-203). There is an activation server to verify that account is live, which is checked periodically (step 204).

The processing stage 220 involves the request 221, a calculate response step 226, and response 230. The request 221 includes, at a minimum, a client ID 222, and one or more target item or user IDs 224, and a type 223 (e.g. best, similar items, related items, etc.). The request also usually includes a response format, e.g. XML, csv or tab delimited, number of recommendations requested, and minimums (as previously discussed). For re-use and estimates, the target user ID is required, along with one or more target item IDs. For types 1 and 9 without re-use, the target item ID is required. For types 5 and 6, the target user ID is required. The calculate response step 226 involves the table lookup 225 for types 1 through 9, or calculation of estimate 228 for type 10. The response 230 includes 10-20 recommendations 231. The recommendations are item IDs for types 1-4 and 7-9, user IDs for types 6 and 7, and an estimate for type 10.

For type 10, the recommendation data 203 includes, at a minimum, correlations for correlation based methods, and features for matrix simplification methods. Calculation of estimate 228 involves creating the neighborhood and estimate for correlation and multiplying the features for matrix simplification, as fully discussed in sections 4 and 5, respectively. The response 230 is simply the estimated rating 232, and can be combined with other recommendation IDs 231, if desired.

SOAP and XML are current standards for web services, but can easily be replaced by any future standard, or the web service could use calls with inputs in the call routine (like in standard C++) and text or binary responses. The web service may also use REST. Alternatively, the recommend component 120 does not need to be a web service, and could be any web language, such as PHP, Ruby, ASP, ASP.NET, Java, JavaScript, Perl, AJAX, Python, and TCL, and implemented in any web framework, such CGI, Ruby on Rails, Django, and AJAX framework.

Preferably, the recommendation web service 121 runs behind the firewall of the client's website. This reduces traffic across the web which could cause delays, keeps the client's data private from the recommendation manufacturer (and Internet spies, although secure connections can be used), and enables the client to manage reliability. The client's website may be hosted on their premises, at a third party hosting site, or managed by a web agency (a.k.a. interactive agency). When the recommendation service is hosted by the web agency, the agency can use one server to host several clients, reducing costs. Alternatively, the web service can run on a server owned by the manufacturer of the recommendation system. This has the advantages of having one server share many clients, and not requiring the client or their design team to setup or maintain the web service, thus reducing costs.

Combined Results

In some circumstances, it is preferable to combine results. In one case, the client sends several item IDs, such as the items in the shopping cart for an ecommerce site or the top items returned from a search, and the result is likely items for that group of item IDs. This is calculated in the same fashion as likely items, except that the group of item IDs replaces a customer purchase history of item IDs—and the similarities are combined for the group of item IDs, where, if a specific item is related to two or more target items, the similarities are summed. If a customer ID also exists in this call, use-once items are removed if the customer has acted upon these items. The input to the recommendation component further includes the number of item IDs and a list of item IDs rather than one item ID. The results are normalized, and a simple sigmoid can be used since the list usually includes a few item IDs (since it's based upon one shopping experience), rather than hundreds or thousands that are possible with likely items (since this is based upon a year's worth of shopping).

In another case, such as when a user is viewing an item and the input includes the item ID and user ID, the cross section of related items for the item ID and likely items for the user ID can be used to recommend items. In other words, if an item is in both the related items list for the viewed item and likely item list for the user, it is returned. The mixed score can be the sum, average, minimum or maximum of the similarity and likelihood—or any combination. In this case, it is better if the related items and likely items lists are long, such as including 40 to 100 items, so it's likely to find an item in both lists. If the client requests a number of items, e.g. 5, and there are less than that number, the items with the largest similarity or likelihood can be used, top sellers, or promotions—as previously determined for that client or entered during training or the recommendation request. This case could include an additional type, e.g. type 11, for the recommendation call, or a new call, such as CrossSection, where the call includes both the item ID and user ID.

In a preferred call, labeled combined, the preferred implementation for the case with one or more target item ID(s) and a target user ID is to combine all related and likely items, and sum the similarities for items related to two or more item IDs, or an item related to one or more item ID(s) and a user. The summed result is scaled, such as by a simple sigmoid.

Similarly, if the cross-sell items are requested, one or more target item ID(s) and a target user ID are included, the items related to the target item(s) are combined, and summed if related to two or more items—to create a result list. Then, for each likely item for the user ID, if the item ID already exists in the result list, the likelihood is added to the sum, otherwise it is ignored. This process means that the target user changes the order of the recommendations, but only cross-sell items are recommended. This is beneficial since while a user is looking at an item, the client may only want to show items bought with the viewed item.

Hierarchy

There is a hierarchical approach that optimizes recommendations if not enough exist. The basic hierarchy is:
Level 1: Item-to-Item
   Item-to-item related items
   Likely items based upon item-to-item related items
Level 2: Intelligent
   Categorical related items
   Similar-to-related items
   Likely items based upon categorical related items
   Likely items based upon similar-to-related items
Level 3: Similar
   Similar items
Level 4: Top Sellers
   Top sellers for all historical data

Requests enter in the correct hierarchical level, and keep falling down to fill out recommendations. Items in each hierarchical level can be combined to find optimal recommendations, but one level cannot replace another level. When combining items in a level, if a specific type of recommendation, such as related or likely, is requested, the non-requested type only boosts items in the requested type in the case of repeat items, or else is used to fill in blank slots in the recommendation list. The best recommendation type enters at level 1, and if it includes a target user ID and at least one target item ID, the related and similar items in each level are compared.

More specifically, if the best type of recommendation is requested, the calculation of the recommendations is as follows.

The item-to-item related items and likely items are used first. If multiple target item IDs are included, the related items are combined where similarities are added for repeat related items. If a target user ID is included, likely items are combined with the related items, and the similarity and likelihood for repeat items are added. The items with the largest similarity/likelihood sum are the recommendations.

If not enough recommendation can be determined from the item-to-item level, the intelligent level is used to fill in the rest of the list. Intelligent items cannot replace or affect the order of item-to-item recommendations.

If both categorical and similar-to-related items are included, the related items are combined and the similarities for repeat items are added. If multiple target item IDs are included, the related items are combined (possibly for both categorical and similar-to-related items), and the similarities are added for repeat items. If a target user ID is included, the likely items are combined with related items, and the similarity and likelihood for repeat related and similar items are added. Once again, this is done for likely items based upon categorical and similar-to-related items, if both methods are included. The items with the largest similarity/likelihood sum are the recommendations.

If not enough recommendations can be determined from related items, similar items are used next to fill in the rest of the list. If multiple target item IDs are included, the similar items are combined with repeat items having their number of actions summed.

If not enough recommendations can be determined from related and similar items, top sellers across all historic sales are filled in. As always, out of stock and use-once items are not included in recommendations. There should always be enough top sellers, and the resulting recommendations are returned.

If the related items type of recommendation is requested, the calculation is identical to the best type with one difference. The difference is that likely items cannot replace related items. However, if a target user ID is included, the likely items can promote existing related items by adding the similarity and likelihood. This boost but not replace rule is true for likely items both level 1 and 2 (noting that recommendations from level 2 cannot replace those of 1, as true for the best type).

If the likely items type is requested, the calculation is identical to the best type with one difference. The difference is that related items cannot replace likely items. However, if a target item ID is included, the related items can promote existing likely items by adding the similarity and likelihood. This boost but not replace rule is true for related items in both level 1 and 2 (noting that recommendations from level 2 cannot replace those of 1a, as true for the best type).

If the intelligent related items type is requested, the calculation is identical to the best type with two differences. The first difference is that the hierarchy is entered on level 2, and then goes to level 3 if not enough recommendations are calculated from level 2. Recommendations from 3 cannot replace those from 2, but only fill out the recommendation list. If not enough recommendations are available from level 3, the calculation moves to level 4, as with best. The second difference is that likely items cannot replace related items. However, if a target user ID is included, the likely items can promote existing related items by adding the similarity and likelihood.

If similar items type is request, the calculation enters in level 3, and if not enough items are available, it fills the rest from level 4. If top seller items type is requested, the list is filled with items from level 4—and every system should have at least 10-20 items sold.

Equivalently, best users, related users and similar users could be found using this hierarchical concept. Furthermore, the hierarchy could always go to a lower level, except when entering at level 2, then going to level 1, and then level 3 and 4. Items on different levels still only fill or boost, but not replace items from previous levels. The logic with this exception is that if the client requests related items, level 1 is closer to level 2 than level 3. The logic with the preferred hierarchy is that level 2 is more similar to level 3 in that both are likely to have top sellers.

Promotions

Promotions can be substituted into recommendation if there are not enough items or based upon a rule that substitutes top sellers and/or promotions if the similarity or likelihood is below a threshold. The promotions can be included if not enough of recommendations of the specific type are available, before moving to similar items, or before including top sellers. The threshold can be predetermined, set in training or an input to the web service calls. If categorical training is included, the promotions can be intelligently included to items of related categories to that of the promotion based upon a pre-action weight—in other words, a predicted number of actions. Preferably, promotions are handled by the control panel, and move into the recommendations properly for each recommendation tout.

Manufacturer and Distributor/Dealer Recommendations

When using the number of items ordered summed over the historical period, as discussed above, the recommendations of a numeric “ratings” algorithm is the estimate of the number of items that a distributor should order from a manufacturer. The difference between the estimates and actual orders can be used to suggest items to distributors, such as when the order online, via the phone or email (where the distributor is the user in the system described in this section). Furthermore, these differences can be multiplied by the item's price, taking into to account tiered pricing, to determine the recommendation with the most revenue associated. Alternatively, profits, such as price of item minus cost of goods sold, can be used to find the recommendation with the largest profit.

When the distributor orders are scaled, as discussed above, the output of the training algorithm can be used to suggest items related to the one's that a distributor has ordered (just like with a user), or create bundled items based upon distributor orders. These related items can then have their order size estimated by the ratings algorithm, as described in the next subsection.

Related Items and Estimated Ratings

FIG. 2J shows method to combine related items and estimated ratings can be used to optimize recommendations when the target item and user are both known, and there are ratings. The process can also uses any method to find items related to the target items, such as the correlation methods discussed in section 3 of this application. Then, the estimated ratings for each related items are determined, given the target user—using any method, such as those described in sections 4 and 5 of this application. The items are then arranged by their ratings and presented to the user. The target item may have several items, such as if several products are in a shopping cart, and the related items are a combination of all related items to each target item, where the likelihood for repeat related items are summed (as discussed elsewhere in this application).

The ratings may be obtained from user ratings and reviews, or they may be the order size as described in the previous subsection.

Similar Items and Inventory Control

When a new item or existing item is being acted upon (e.g. bought or built), a similar item can be used to determine how many each users (defined in this case as customers, dealers or distributors) will order. The estimated rating for each user and the similar item is summed for a total. If the rating is an order size, the sum can be used as a basis for a manufacturer to determine how many to build. The sum needs to be scaled down since every dealer won't order, and that scaling factor can be determined from statistics, such as the average number of users that purchase the similar items divided by the total number of users. If the rating is the likelihood of a user buying the item, or number they will buy, the sum can be used to determine how many to buy. Once again the sum is scaled down. Similarly, pre-orders can be used to then estimate the orders for other dealers and distributers using methods discussed here.

Furthermore, a non-rated method can be used. In this method, the related items for the similar items are found. The likelihood that a related item is acted upon is multiplied by the times that the related item has been acted upon. This is done for each related item, and the results are summed. The sum is the number items to build or buy.

In either method, several similar items can be used and the results are averaged to produce a better inventory estimate. In addition, the time period for order sizes, ratings and determining likelihood should match the time period for which the inventory is to be acted upon.

Website Component 140 (Part B)

As discussed in Website Component 140 (Part A), the website captures the historical data for training. The website also provides the recommendation request 221 and displays the response 230. It uses the web service, which in turn, uses the recommendation tables created by training. Note that historical data can come from physical sales, eBay sales, etc., and the display could be at a display, such as pricing station, at a store.

Most websites are made from 4 to 5 templates. In a simple example, there is one template for every product category, known as a product landing page, and one template for the selected product details, known as a product detail page. Thus, for this example, these two templates dynamically create web pages for every product category and every product. With the addition of one line of source code, which is a call to the recommendation web service 121 for both templates, every product category and every product web page has one or more recommendations. Each recommendation includes item IDs, which is displayed in the exact same method as other products are displayed in the templates. By sending user and/or item IDs, and receiving item IDs, this system is very efficient since this is the fashion in which web designers already have designed and interact with the website. Using recommendation response templates, which seem simple to integrate at first glance, require the integration of the response templates look and feel, and take longer than returning item IDs.

These 1 to 20 recommendations can be used in many fashions by the web page, as incorporated by the website designer. For example, when viewing an item's web page, the web designer can choose from the recommendations to show:
Three best items
Three related items
Only items with more than a 70% similarity rating
Two related items and one promotion
One related items in the same category, one recommendation in a different category, and one promotion (assuming items have category fields in the item database)
Two related items in the same category, and one item in a different category
One item related to the viewed item, one likely item based upon the user viewing the web page, and one promotion.

When viewing the shopping cart, it is suggested that a mixture of only related, likely items and promotions are listed, as similar items can be distracting.

The item IDs recommended by the recommendation web service 121 are used by the web page to retrieve the item information from the web page's item database. More specifically, first the web page calls the web service, and then the web page looks up the information in the item database to display the information, such as item image, short description and price. Several other aspects could be displayed. This process is created by the website designer.

Furthermore, the website could return similar and related items to those returned during a search, such as a search based upon keywords. Specifically, one similar and one related items are shown horizontally next to each search results, which is shown vertically. This helps broaden a search and locate items that a user is interested in. The related items could be related to each item returned in the search, or likely items for the group of top items returned during the search.

Finally, the complete workflow for the website to interact with recommendations is shown in FIG. 2E. The times are estimates for an average client.

Email Components 130 and 150

The email components 130 and 150 enable recommendations in email in three methods. The emails can include discounts for promoted or likely items. The email workflow is shown in FIG. 2F.

In the first method, the email is only sent to likely users for a promotional item (i.e. users likely to buy that promoted item). This is beneficial since the client can send out more emails, not bother users with too many emails since every user does not receive every email, and reduce opt-out of emails. In this case, the email service 131 exports the likely user IDs for a promotional item. The number of likely users may be more than half of the number of total users.

In the second method, the recommendations are inserted before the email is sent. The sending email system enables a lookup of likely items, and the top few items that the email recipient (i.e. user, but the term recipient is used to clarify it's not the sender) is most likely to act upon are inserted into the email. Optimally, the email is created with a template that includes a lookup request which is handled by a proprietary lookup directly into likely items table for the email recipient or via the web service. As such, in this case, the email service 131 can be thought of as a pass through, and is the likely items table from recommendation data 112 or the recommendation web service 121, respectively. This is preferred for integrating the recommendation system into proprietary email service provider's systems. This method is also preferred for email service providers that allow, or will allow in the future, a tab delimited file for the email template. In this case, the email service produces a tab delimited file with each user ID and the top few recommended item IDs on each line.

In the third method, the recommendations are inserted when viewing the email, and do not require the participation of the email service provider. The receiving user email component 150, such as Microsoft Outlook, dynamically receives recommendation upon opening the email 151, and selecting download images, if security is set at that level. This is preferred for email service providers, such as Yesmail, Vertical Response, Eloqua, etc., since they limit their clients access to the front end, but do enable inserting a dynamic link in the email template such that the recommendations can be created when the email is read. In this case, the email template includes a dynamic link that contains the client ID, user ID, format and position of the recommendation (assuming random is not selected), such as http://www.4Tell.biz/email?ClientID=12&UserID=132&Format=1&Pos=2, where the user ID is inserted uniquely for each user (i.e. email recipient) by the email system. For an image, the dynamic link is included in an image tag, such as <img src=“dynamic link here”>.

The dynamic link is received by the email service 151, which causes a recommendation table lookup for one likely item based upon the client ID and user ID. Then, the email service determines the likely item's webpage link or likely item's image link. Finally, the email service returns the likely item's thumbnail image (i.e. small) or redirects to the likely item's webpage. The lookup can be done by the recommendation web service 121, and the web service can do it all with the return being switched to links rather than XML, based upon the format parameter.

This example assumes that the second best recommendation (i.e. pos=2) for this client and user is item 14. In this example, the returned image could be accessed via a dynamic link http://www.client.com/image?ID=14, preferably dynamically created by the database (such as with Adobe Scene 7), or static link http://www.client.com/item14.jpg. The item redirection link could be a dynamic link http://www.client.com/item?ID=14, preferably cause the database to dynamically export the link, or static link http://www.client.com/item14.html. Ideally, these links have a base template, such that the email service 151 only needs to know the image template and item page template and fill in the likely item ID. The example dynamic links shown above are from such a template for likely item ID=14. The two templates are created by the client before the email is sent, and saved for use by the email service. If the links are not from a template, the action database 141 must export a table with item ID, image link and webpage link, or enable access to return the links given the item ID, such as from their website database. The end result is an email personalized for each user, thus increasing the likelihood of an action, such as product purchase.

If spam filters start blocking emails with the dynamic links, the link could be static with the necessary IDs embedded in the image or link name, and the link includes a path that knows how to parse the names to dynamically link to the image or redirect to the item's web page. For example, using the same client 12, user 132 and format 1, the email template links are http://www.4Tell.biz/email/CID12UID132F1.jpg for the image, or CID12UID132F1.html for the web page redirect. In this case, the email folder of 4Tell.biz knows to break the link into client ID=12, user ID=132, and format=1, and then dynamically return the thumbnail image or redirect to the proper page as described for the template method described earlier in this subsection.

For the image and item page link, if three likely items are desired, a dynamic link is needed for each likely item image, and another dynamic link for each likely item product page link, resulting in a total of 6 dynamic links. In addition, such that a recipient doesn't receive the same recommendations with each email, the system can be designed to randomly return one of the top N items, where N is usually 10 or 20, and the item return is saved such that it is not repeated for a predetermined number of days, such as 90 days. In this case, the format parameter can be used, or random can be the default method, and the last date that a likely item is used in email has to be saved.

It would be optimal to use a response template that includes both the image and link, such as <img src=“http://www.client.com/product14.jpg”><a href=“http://www.client.com/product14.html”>Product 14 Description text here </a>. Most likely the image would be inside the link so it links to the product page, but is not for ease of understanding. However, the response template would require some web programming that may not work with all email viewers since it's returning more than an image or new web page. If using a response template, the templates are made by the client, and saved with a format ID, before the email is sent out. The templates can include multiple items, such that if three likely items are desired, only one dynamic link is needed. Furthermore, the response template can include item descriptions, which must be exported or accessed from the database.

Email methods two or three can be created with likely items limited to a few, such as 20 items. More specifically, the most likely few items from this limited list are sent to an email recipient. This limitation is preferable since it reduces the time to create the database for the dynamic response templates. Furthermore, some email service providers enable or require clients to upload images to the email system. As such, only a limited few images need to be uploaded. These same providers already allow, or may allow soon, a tab delimited file for the email template.

Control Panel Component 160

The control panel component 160 enables the client to dynamically control the recommendations on the website at the tout level, where a tout is the specific recommended item shown on the website. For example, the client can add promotions or change the tout from showing a related item to a top seller or promotion. This is done without changing the website design, i.e. template, or web service call. During the website design, each tout for each website template is grouped and included in an XML configuration file 161. Thus, the file may have 5 touts for product detail pages, 3 touts for checkout pages, 3 touts for category landing pages, etc. An example configuration file for a website with recommendations in product detail pages and checkout is shown in FIG. 2G. The file doesn't have to be XML.

The control panel is based upon a template that includes a few variables:
Return Type=Best, Related, Comparable, Likely, Categorical, Top Sellers, Promotion, etc.
Minimum relationship=Likelihood or similarity below which a recommendation should not be used
Minimum Common=Common users below which a recommendation should not be used (usually for correlation based techniques, but can also be applied to any technique)
Alternative Return Type=same parameters as return type, but for touts that don't have a return type greater than the minimum threshold (optional)
Promotion Inventory=True or false, whether best or categorical recommendations should monitor inventory to affect the promotion's weight (optional)
Price=Limit price of item listed in recommendation, such as limiting to 25% of total purchase or 25% of price of target item (optional).

These variables enable complete control of recommendation touts by marketing without editing the website. They do not allow the number of recommendations or location on the website to change, just the actual recommendation placed in the tout. The return type tells the type of recommendation to return. The default is best and the system takes the parameters in the web service call and determines the best recommendation. For example, if an item ID is included, the related items are returned, if an item ID and user ID are both included, the overlap of the related (a.k.a. cross-sell) and likely items (a.k.a. up-sell) items are used. Otherwise, the result type directly specifies similar, related, likely, categorical, top seller, promotions, etc. If not enough recommendations above the minimum likelihood are available, or not available (such as asking for up-sell without a user ID, the alternative return type is used. If still not enough recommendations are available, the web service defaults to returning top sellers—and if categories are included, the top sellers are from the same or related categories (known as categorical related items, described briefly in this section, and described in detail in the hierarchical section later in this application). The promotion stock is set to determine if the best and categorical return types monitor the inventory value to adjust the weight.

Preferably, an alternative type is not used, and the algorithm has a hierarchy, as previously described in the hierarchy section. The alternative type can be used with the hierarchy, and over ride the path.

The control panel allows the client to set these variables, and then the recommendation web service uses these parameters in determining its return. In other words, these parameters are left out of the web service call that is coded into the website such that these parameters can be dynamically changed without touching the website. Optimally, the web service call includes the user ID if the user is logged in, allowing the control panel more flexibility, since without a user ID, best and likely responses are limited.

The control panel is preferably graphical. The control panel reads the configuration file, displays each tout for each template, along with template and global settings. For example, each template is shown as a tab, and within each tab, the touts are shown with drop-down menus to select the parameter, as well as settings that apply to all touts in the template. There is one additional tab that includes global settings. The priority is that tout setting are followed first, then template settings, and then, if there's no tout or template setting, the global settings. There is also a selection to reset tout and template settings with the global settings, or tout settings with template settings.

For each tout the user can select the return type, minimum likelihood and alternative type from a drop-down menu. Furthermore, the website designer could group several website templates into one recommendation template, if the same number of touts is included in each template.

Finally, the control panel enables promotion items to be entered from a list of products (noting that the promotions category is automatically known from the item list), with the ability to set the promoted items weight. The promoted items can be linked to a tout, template or global setting. In addition, the control panel enables items to be pre-related. For example, the client can preset the similarity of a bikini bottom and top at 100% or pants and belt at 50%. Optimally, these are global setting that enable the linked item to be displayed whenever the other item is selected. However, they can be set for a template or tout. For example, the bikini bottom is only showed if the bikini top is viewed in a product detail page, and not if viewed in a category landing page (with several other products).

The control panel is simple, but enables incredible flexibility, especially with promotions. The simplicity is required to minimize total cost of ownership. Regarding flexibility, for promotions, the control panel enables the client to fix a promotion at checkout, or set its pre-weight with a pre-sales so that it will be intermixed with best or categorical recommendations (more later), or pre-weight it with a pre-similarity such that it is linked with another item. Most importantly, each tout can be controlled in a logical fashion. Every setting can be set for each tout, for each template or globally.

Additional Improvements

Marketing/Buyer Tool

A marketing/buyer software package provides recommendation display that enables company marketers and buyers to understand the recommendations, such that they can better perform their job. Marketing can bundle products and determine when an out of stock item should be restocked. Buyers understand how to group buys to match what sells together. Many online retailers also have a physical store, and can use the recommendations, including items and categories that are highly related to arrange the items in the store.

Previously Acted-Upon Items

If items are marked with a category, possibly as simple as use-once, the historical data 101 is linked to the category field for each item through the item details. Then, the historical data 101 can be checked so that previously acted-upon items are not displayed for the given user. This checking can be done by the train component 110 when the training for likely items and likely users since these recommendations are for a user ID, item ID pair. For likely items, if the target user has acted upon the likely item, and the item is tagged as use-once, the item is not included in the likely item list. For likely users, if the target item has been acted-upon by the likely user, and the target item is tagged as use-once, the user is not included in the likely user list.

For related items, the user ID is not known during training, but only when related items are requested while that user views the web page. In this case, the recommend component 120 receives the item ID and user ID, and then checks to see if related items that are tagged as use-once, have been acted-upon by the user. If so, the related item is not included in the related item list returned to the website. The downside is that this method will require the recommend component to keep the historical data 101 for each client in memory, thus reducing the number of simultaneous clients. In addition, it requires more computation for the real-time part of the system.

Alternatively, the website programmer could handle this task by checking the action database 141 for every recommendation presented to the user, or every recommendation tagged as use-once. In the latter case, the use-once tag is included as a field in the historical data, as well as included with the recommended item, such that a recommendation comprises an item ID, similarity or likelihood, use-once/re-use tag. This is advantageous since the web page is already using the item database, but requires more programming by the web programmer.

The category tag may be more complex that use-once or re-use. The client (e.g. website owner) may not want to show previously acted-upon items in some categories, while show them in other categories. For example, the system shouldn't recommend household or CE devices, such as stoves, refrigerators, DVD players, nor entertainment, such as items, CDs or games that have been bought, but show clothing that has been bought. The logic is that devices and entertainment have a several year lifespan whereas clothing has a much shorter lifespan. For this implementation, the historical data also must have a category tag and/or use-once/re-use tag with the item ID and user ID.

Popular Recommendations

Recommendations can be ranked by popularity, defined as the number of actions associated with the item or user. In one method, the user or item is not included in the recommendation list if the number of actions does not meet a threshold. The threshold will depend upon the number of total actions. An example threshold for an item is total number of actions, divided by the total number of users, divided by 50—in other words, 50 times less than the average actions on that item. Equivalently, the item can be replaced by a user for user recommendations.

This method is good for large e-commerce sites, but has the issue of eliminating new items from recommendations. In another preferred embodiment, which is better for specialized websites that want to promote new items, the similarity or likelihood is scaled. For related items, the similarity is scaled by the number of actions upon the item or common actions on the item pair. For related users, the similarity is scaled by the number of actions by the user or common actions by the user pair. For likely items or likely users, the scaled similarities are used in determining likelihood. Specific formulas, such as using log of common actions, are described below in sections 3 and 4. The optimal method to include popular items is through categorical training, as discussed above.

Viewed Recommendations

There is logic to keep purchased, rented or played items, labeled e-commerce items, and viewed items separate, rather than combined the e-commerce actions with viewing actions. Thus, recommendations for related items based upon e-commerce items include items “bought” together (or cross-sell items), whereas recommendations for viewed items are viewed together (or similar items).

This is only a trend for matrix simplification based algorithm as the algorithm above can recommend items that are not “bought” together. This trend is stronger for nearest neighbor algorithms or any other “bought together” algorithms that find related items based upon one user acting on both items.

Similar, Related, and Likely User Selection

When determining to act upon an item, such as viewing it on the website, a user may want to be shown similar items that are bought instead of the item, such as this dress or that dress, or they may want to see related items that are bought with the item, such as a belt for the dress, (labeled cross-sell items). Additionally, the user may want to see other items they are likely to enjoy (i.e. likely or up-sell items). The user could select a radio button or tabbed display to the proper recommendation, such that the algorithm doesn't need to automatically determine the user's preference—although the algorithm does need to differentiate similar, related/cross-sell and likely/up-sell items. In correlation based algorithms, the similar or cross-sell items are based upon whether action data or view data is input. In more complex algorithms, such as matrix simplification or clustering, where similar and related recommendations come from the same input data, the algorithm can differentiate similar and relate items by the number of common users, such as 0 or 1 common users represent related items and 2 or more common users represent cross-sell items.

Category Type 1 and Category Type 2

The categorical training and similar-to-related items have been described in terms of general categories, with a preference to have two category types, brand and product type. This is optimal for e-commerce websites. However, the recommendations work for any item, and category 1 and category 2 can be any two category types. For example, if a manufacture of clothing is selling online, the brand is a useless category. The manufacture may want to use category 1 as product type, such as shirt, pants, socks, etc., and category 2 as color, especially since they have a limited number of colors that are constant between products. They could use the SKU for item ID, which includes color and product code, but this may also include size, and does not enable the intelligent/categorical training.

Another usage scenario is suggesting classes for college students. In this case, the training uses years of data linking class ID and student ID. The category 1 can be class department, and category 2 is student department. Thus, categorical recommendations show classes taken by students in the same department and also have taken classes from the same department. In this scenario, the item-to-item recommendations could be modified by the category similarities of the recommended items, such that the results are classes often taken together, and by students from the same department and the class is in similar departments. In this case, it's important to notice that since the category 2 is linked to user (i.e. student), each department in category 2 will be linked to itself, unless a lot of students switch from one department to another.

Computer Implementation

The train component 110 and historical component 100 are combined to create the training program. If use-once tags are not included, the recommend component 120 is the recommend program, and, otherwise, the recommend component 120 is combined with the historical component 100 to create the recommend program. The email components 130 and 150, and optionally the recommend component 120, are combined to make the email program. The website component 140 is equivalent to the website.

In the preferred embodiment, all programs are running on one computer, and website on another computer. This is done to reduce cost of ownership. Alternatively, the training program and email program are running on one computer, recommend program on a second computer, and website on a third computer. This is done for maximum efficiency, so training doesn't slow recommendations and web browsing. However, the training program and recommend program can be running on one computer or two or more networked computers. In fact, all programs and the website could be running on the same computer. In most cases, the historical exporting (if applicable), training or email are done at night. It is likely that the training computer and recommendation computer are handling several clients.

Memory Usage and Multiple Clients on One PC

Memory usage with 10 recommendations for 100K historical entries with 10 k items and 50 k users Historical Data=780 KB

=100K entries*(4B item ID+4B user ID)

Each Similar Items, Related Items and Likely Users Table=860 KB

=10,000 items*(8B for item ID and num actions+10 recommendations*(4B for related item ID+4B for similarity))

Each Likely Items and Related Users Table=4.2 MB

=50,000 users*(8B for user ID and num actions)+10 recommendations*(4B for related user ID+4B for similarity/likelihood))

Why Items (with three per likely item)=12.9 MB

The file size is slightly larger since text files are used.

Thus, for item recommendations, there is one similar items table, three related items table, one likely items table (since likely items based upon item-to-item, categorical and similar-to-related items are combined in one table), the memory usage is around 7.6 MB for re-sell, and 8.3 MB for sell-once. As such, numerous clients can be run on one system, thus reducing cost. In fact, the processor speed will probably be the limiting factor over RAM usage, and the number of clients on one machine will depend upon processor speed and web site requests—along with other items running on the recommendation web service server and whether it is determining if items have been previously acted-upon, which should reduce the number of simultaneous clients to around 10. It is expected that 10-100 or so simultaneous clients can run on one machine.

3. Correlation Training for Non-Rated Data

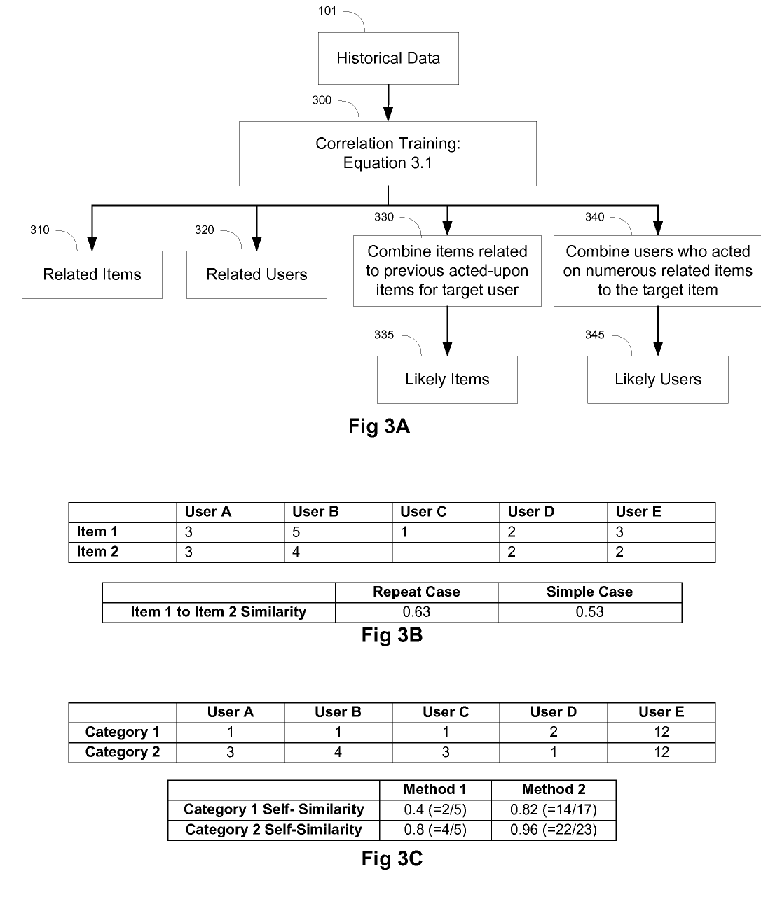

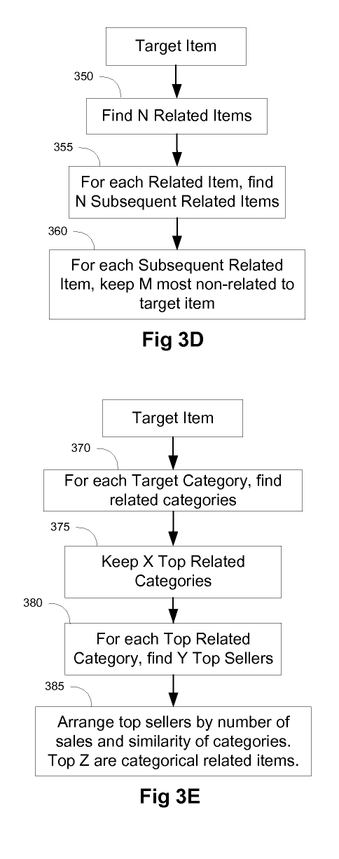

For data that has not been rated, but only viewed, purchased, bought or rented, a preferred training algorithm is correlation, also known as k nearest neighbors (KNN); thus, the data is nominal. The recommendation system is described above. The algorithm uses cosine similarity. The training algorithm is shown in FIG. 3A.

Correlation training 300 is used. The algorithm counts the number of times that a user acted upon both items (labeled N₁₂), and divides it by the quantity of the square root of the quantity of the number of times item 1 was acted-upon (labeled N₁) times the number of times item 2 was acted-upon (labeled N₂) plus a threshold (Nₜₕ), as shown in equation 3.1:

Similarity=N₁₂/(sqrt(N₁*N₂)+Nₜₕ) [3.1]

The threshold count, Nₜₕ, is used to weight items with more ratings, more heavily, and 25 worked well where items are rated by an average of 5000 users. In other words, Nₜₕ is the number of data points divided by both the number of items and 200. For data with fewer purchases, the threshold has a minimum in the range of 1 to 10, with the value of 5 as the preference. The similarity of item pairs with few, such as 1 to 5, common users can be removed. The preferred embodiment removes any recommendations with a similarity below 0.1 and only 1 common user.

In the simple case of converting actions to numeric values, repeat actions on an item by a user are representing as one action in both the total number of actions and potential common actions, thus removing its affects. This is good for items with few repeat actions, as discussed in the Historical Component subsection of section 2. For example, with college classes, retaking a class is infrequent and can be ignored for training.

However, the preferred embodiment includes repeat actions since, for smaller websites, every action is important, and many items are bough repeatedly. The process, as discussed in section 2, is to maintain a count of actions for each item by each user. Then, in equation 3.1, the count is included in the total actions, and the minimum of the count of actions of a target user on both items is used for the common actions. In other words, the common count is the number of time a target user acted on both items, where each action can be paired with another action. Optionally, a maximum count of actions on each item can be used, so one user that buys a lot of two items doesn't skew the results.

For example, FIG. 3B shows number of actions for 5 users on two items. For this example, the total count for item 1 (N₁) is 14, the total count for item 2 (N₂) is 11, the common count is 11 (N₁₂), and the similarity is 0.63 for Nₜₕ=5. In comparison, when the repeat actions are ignored, the inputs are N₁=5, N₂=4, N₁₂=4, Nₜₕ=5 and similarity is 0.53. The table in FIG. 3B is a graphical representation, and in computer implementation would be stored as an indexed list or jagged array, so user 3, item B doesn't waste memory.

The affect of users that acted only once can optionally be removed. In one method, these users are removed from the historical data, and the similarity in equation 3.1 is calculated using either method above (including repeat purchases or not). In other words, the similarity equation uses the number of common users divided by number of actions by users with more than one action on any item. In another method, the similarity equation uses the minimum of the count of actions of a target user on both items divided by the total actions on each item without users who only acted on that item.

Other variations of equation 3.1 can be used, such as using the minimum or maximum of N₁ or N₂. Alternatively, N₁ can be used when obtaining the correlation of item 1 with item 2, and N₂ when obtaining the correlation of item 2 with item 1—and this method results in a non-symmetric correlation between item 1 and 2.

Furthermore, the log of the number of common ratings, N₁₂, could be used to further scale the weights towards items with more ratings. The drawback is that it will be even harder for new items to get a high similarity rating. In addition, a sigmoid (e.g. equation 2.1) can be used on the final weight, such that it always remains less than 1, and the affect of the number of ratings is still applicable but reduced in magnitude.

The similarity is used to determine the related items 310 by choosing the largest K, usually 10-20, similarities as the related items 310.

Equivalently, users could replace items and use equation 3.1 to find related users 320.

For likely items 335, defined as items that the target user is most likely to act upon, the previous 30 actions or 6 months of a target user actions can be used, and related items for each action are combined into a list with item ID and likelihood (box 330). If a related item is repeated, its similarity is summed with the previous similarity. The items in the combined list with largest similarities are the most likely items. Additionally, any time period or number of user purchases can be used, up to all of the purchases included in the historical data (as used in section 2). Number of purchases is preferred since monthly purchase rates can vary. Furthermore, it is best if the number of related items is 40-100, about 4 to 5 times the number of related items that are saved in the related items recommendation table.

Likely users 345, defined as users that are most likely to act upon the target item, can be found from users that acted on numerous (like 400) related items to the target item (box 340). The users are ranked by the number of related items that the user acted upon. Alternatively, the previous 30 actions or 6 months of user actions on the target item can be used, and related users for each user action are combined into a list with user ID and likelihood. When a related user is repeated, its similarity is summed with the previous similarity. The users in the combined list with largest similarities are the most likely users. Additionally, any time period or number of user purchases can be used, up to all of the purchases included in the historical data (as used in section 2). Number of purchases is preferred since monthly purchase rates can vary. The likely item and user methods are discussed in detail in the section 2.

Efficient Computer Implementation

The computer implementation to efficiently find common users is, for each item, find the users that acted upon that item, then for each of these users, for each acted-upon item update the common count. The common count can be updated by 1 or the minimum number of actions, as described above. This implementation is way faster than looping through every user and finding matches since the data is so sparse. It requires the historical data to be arranged by customer and user, as described in section 2.

Genomic (a.k.a. Categorical) Training Using Correlation

Categories, previously defined as product type, brand, color, genre, gender, etc., can be trained using equation 3.1 with the count representing the repeat actions of a user in the category (i.e. repeat conversion). It is important to use repeat actions for categories, since even if items are only acted upon once, the category includes numerous items, and thus, numerous repeat actions.

Furthermore, categorical training must find the similarity of the category to itself. For example, if the user acts upon an item in MenClothing/T-Shirts, they are likely to buy another item in that category. However, if they buy something in Furniture/Couches, it's more likely they buy another item in Furniture/Pillows.

There are two methods to find self-similarity, both using equation 3.2, with the variables defined slightly differently.

self-similarity=N_{c}/(Nᵤ+Nₜₕ) [3.2]

In the first method, the number of users with more than one action on the target category (N_{c}) divided by the number of unique users for that target category (Nᵤ), as shown in equation 3.2. In the second method, the total number of actions by users with more than one action on the target category (N_{c}) is divided by the total number of action for that category (Nᵤ). FIG. 3C shows exemplar data and results. The first method is preferred since it is not swayed by one user buying a lot of one item, such as a quasi-distributor (such as an eBay seller) buying a lot of one item. The threshold (Nₜₕ) can be calculated as describe for equation 3.1 with a minimum, such as 5. The equivalent self-similarity can be calculated for a user to determine if they are likely to be repeat users.

As discussed for equation 3.1, the actions of users that bought only one item can be removed, and then the self-similarity are calculated with either method. This means that, for the first method, the number of unique users does not include users with only one purchase, and, for method two, the total number of actions on the target category does not include actions of users with only one action across all categories.

Related items for a target item via categories (labeled categorical related items) is calculated by finding the related categories to the target item's category (possibly including the target category if it is related to itself), determining a factor related to the number of actions (Nₐ) for the top items in each related category, the number of target item actions (Nₜ), and the category's similarity (s_{c}) to the target item's category. Then, the items with the largest factors are the related items. In the preferred embodiment, the log of the square root of the number of target actions times the number of related item actions, times the similarity squared divided by a normalizing factor (f) is used, as shown in equation 3.3. The normalizing factor is the log of the average number of actions on items (Nₐᵥₑ).

similarity=log(sqrt(Nₜ*Nₐ)*s_{c}̂2/f, where f=log(Nₐᵥₑ) [3.3]

The following factor has also been evaluated. It is the minimum of the log of the maximum number of actions in the related item's category (Nₘₐₓ) and the value 10 standard deviations above the average of the number of actions on items (N_{ave+10sd}): f=min(log(Nₘₐₓ), log(N_{ave+10sd}).

This equation is used since the log lowers the strength of the few top selling items, and the squared category similarity helps the stronger category. The total effect is to not have one top selling item show up in every recommendation. The factor is used so that the resulting item to item similarities have values equivalent to those calculated directly between two items; thus, the similarities for the related items and the categorical related items can be compared.

Equation 3.4 is used if two category types, such as product type and brand are used, as described in the previous section, where s₁ is the similarity between the target item's product type and related product type, and s₂ is the similarity between the target item's brand and the related brand. The equation can easily be expanded with more category types by multiplying more similarities, and optionally taking 2/M power of each similarity when there are M category types.

similarity=log(Nₐ)*s₁*s₂/f, where

f=log(Nₐᵥₑ) [3.4]

Items in Multiple Categories

If items are in multiple categories, the calculation of the similarity needs to exclude the actions on the items for the multiple categories. For example, if item A is part of category 1a (e.g. hydration backpacks in category type 1) and category 1b (e.g. hiking backpacks in category type 1), the actions on item A are removed from category 1a and category 1b. Actions from the other items in category 1a and 1b are not affected, and actions of item A not related to category 1a and 1b, such as category 1a and 1c are not affected.

The primary category could be selected as the first listed category, and the action in the primary category is included in similarity calculations. The actions in the secondary category or categories is not included. This is beneficial so actions on item A are at least used in one of the multiple categories—noting that this only applies when calculating the similarity between two of the categories of which item A belongs.

The computer implementation is to keep track of the actions to exclude in a 2D array when the item actions are converted to category actions. The implementation removes these actions from the number of actions, including common (N₁₂), category 1a (N₁) and category 1b (N₂). Since the array is a triangular array, a smaller 1D can be used to store the data in a more compact fashion. The index of the 1D array is calculated as the category 1a index times number of categories plus category 1b index, where category 1a index is smaller.

Generalized Genomic Training

As shown in FIG. 3E, this categorical technique can be applied to any method that determines related items, including neural networks, ensemble learning, Baysian networks, and Restricted Boltzmann Machines. The method can be used to find related categories. For the same category, the above equations 3.2 to 3.4 can be used, or the system may find that categories are related to themselves. The general method is, for each target category (i.e. category of the target item), to find related categories, including related to itself, then use top sellers in the related categories to use as categorical related items. As previously described, the related items are ranked by the number of actions and similarity of the category to the target category.

This can also be used with users instead items, with categories including gender, income, zip code (or first few numbers so they are less localized), state, city, or other questions from a registration form, possibly including favorite movie, book, or car, favorite movie, book, car category, luxury or discount shopper, etc.

Continuous Category Types

There are continuous category types like price, clothing thickness, weight, and so on. It is unlikely that items have the same category value, so the values are grouped. The can be grouped by the client during export. However, it is preferred that the training algorithm groups the category values into a reasonable number. Preferably, the categories are created from statistical analysis of the data such that each category has the same number of items. Alternatively, the group could have the same range in each group, or logarithmic range since many distributions follow the logarithmic distribution. This is applicable to item and user categories. The group is used as the category, possibly defined with a category ID to be used in the genomic training described above.

For example, price can be grouped into 5 categories: cheapest, inexpensive, middle, expensive, and luxury. The most straight forward method is to arrange the items by price and choose the price range to include the total number of items divided by 5.

Filtering Categories

Filtering categories help further refine recommendations such that the recommendations match the past actions of the target user. The general method of filtering categories was discussed in the Filtering Categories subsection of section 2 (above) and FIG. 2L. Any algorithm can be used to determine the relationship between the (i) user and item category, (ii) user category and item category, and (iii) user category and item. Note that the user gender and item gender are two different categories, and do not require self similarity as discussed below.

A preferred method to calculate the likelihood, L, that a specific user or user category acts upon a related item or item category is based upon the number of total actions on the related item by the specific user, Nt, and the number of actions from the specific user or user category, labeled specific actions or Ns. The equation is:

L=Ns/Nt [3.5]

For relationship (i) user and item category, Ns is the number of actions by the user on the item category, and Nt is the total number of actions by the user. In other words, if the user acts, the likelihood shows how likely is the action on the item category. For (ii) user category and item category, Ns is the number of actions by all users belonging to (or labeled with) the user category on the item category, and Nt is the total number of actions of all users belonging to the user category. For (iii) user category and item, Ns is the number of actions by all users belonging to the user category on the item, and Nt is the total number of actions of all users belonging to the user category.

Automated Analytics

The relationships (i) between item categories, (ii) within item categories (i.e. self-similarity), (iii) between user categories and item categories, (iv) between items and user categories, and (v) user's and item categories are interesting in their own right, not just for creating recommendations with genomic training or filtering categories. The category types can be for items, such as product type, color, brand, price, gender, etc. The item categories are different groupings in the category, such as shoes, shirt, pants, etc. for product category, or male, female, girl or boy for gender. The category types can be for users, such as gender, location, income, education, etc. The user categories can be the first three numbers of the zip code for location, highest level of school for education.

Retailers can increase sales by understanding how their items are bought. Categories that are bought together should be near each other in a store, and easy to go between on the website. Thus, displaying these relationships, along with similar, related and likely items, in a Dashboard Viewer is very useful for a retailer. The novel benefit is that this type of analytics is automatically calculated from actions, and special reports don't have to be generated. The viewer can simply allow the client to:
Choose an item and view related items (i.e. cross-sell)
Choose an item and view similar items
Choose an item and view related user categories
Choose an item category and view related item categories (i.e. categorical cross-sell)
Choose an item category and view related user categories
Choose a user and view likely items (i.e. up-sell)
Choose a user and view related item categories.
Choose a user category and view related item categories
View the top 100 most related items that should be bundled
Choose one or more items and view related items
Choose one or more target items and a target user and view related items with likelihoods summed if related to more than one target item or the target user, but only show items that are related to the target items
Choose one or more target items and a target user and view related and likely items combined by likelihood, with likelihoods summed if related to more than one target item or the target user

Relationships (i) and (ii), those between item categories and within item categories, have been described in genomic training. For example, it is that a ski is bought with boots and bindings. They are determined using equations 3.1 through 3.4.

Relationships (iii), (iv) and (v), those between items or item categories and users or user categories have been described in part in filtering categories. When the user or user category is the selected item, equation 3.5 as described in the filtering categories subsection is used. The results are the likelihood that a user or user with a category will act upon an item or item with category. For example, a male user tends to buy male clothing, whereas a female user tends to buy male, female and children's clothing, similar to used in filtering categories. Or, this user tends to buy expensive items (i.e. price category), or watch scary movies (i.e. product category).

When the item or item category is the target and the user category is viewed, equation 3.5 is used with the following change. Ns is still the number of actions of the user category, but Nt is the total number of actions on the item or item category. Thus, the likelihood is focused on the item or item category and not the user or user category, and the likelihood represents how likely an action on the item is from a user or user category (not how likely that user or user with that category is to act on the item). For example, the relationship can be that this item tends to be acted upon by men (i.e. gender user category) from the southwest (i.e. location user category).

This analytics tool can be used even for a physical store that does not sell online. In this case, the user actions are linked by a credit card, only if in the same purchase, or affinity card (e.g. store customer ID), such that training can find related categories from multiple user purchases.

Automatic Re-Use Calculation

To automatically determine resell for an item, the self-similarity, using equation 3.2, for an item is calculated, using any method described. If the self similarity is over a threshold, like 0.25, the item is classified as re-use, and if below, it is classified as use-once.

Similar Items

Brute Force

The system can use brute force to determine similar items, those that are related to the same item but not related to each other, as shown in FIG. 3D. The preferred method is to start with a target item, and find related items with any method. Then, for each related items, find items related to the related items, labeled subsequent related items. Next lookup the likelihood between the target item and subsequent related item. For each subsequent related item, keep the 20 or so (e.g. M) least related to the target item as the similar items. The least related item is the item with lowest likelihood or fewest common users with the target item. In case of a tie, the item with the most actions is usually best. The similar items can also be forced to be less than a threshold, such as threshold of 5% or 10% likelihood, or 2 users in common.

Clustering

First of all, with all of these clustering techniques, the group contains both similar and related items. The number of common users is used to separate similar items and related items. Specifically, if an item pair has 0 or 1 common users, they are similar items, and if an item pair has two or more common users, they are related items.

The similarity of item-to-item, categorical, and similar-to related items, where multiple category types are independently calculated, can be used as distance measures to cluster items, such as the inverse of the similarities. Standard clustering techniques, such as k-means are used to group items.

More preferable, since the items move rather than the cluster, is Kohonen self organizing maps. The map uses the related item similarity measurements as the input vector. Similarly, gravity based clustering methods can be used. In one method, the items are randomly placed in space (2D or 3D) and the items moved towards each other based upon their distance and similarities, where pairs with larger distances and similarities move a larger amount closer. The movement amount can be the distance*similarity/2/learning_factor. In another method, each item is given a mass and the similarity is the force that moves them closer for a given time period. Most importantly, the cluster is dynamic, such that, for each item, the nearest N items can be determined, and then separated as similar and related items based upon number of common users.

For example, a pair of pants has a large similarity to two belts, which have low similarity with each other, as well as the pant's product type and pant's brand are related to both belt's product type and brand. In this case, the clustering would show that the belts are related, and since they have few common users, they are similar items. Thus, without using view data, comparable products can be shown to a user looking for a comparable item. This clustering example would work without categorical training.

4. Correlation Based Method Using Negative Correlation and Related Users and Items

For numeric or rated data, or where a significant amount has been rated and non-rated actions have been converted to a value (as described in the historical component section), the following is an improvement upon standard KNN (see references in background section). It is expected that at least ¼ of the data must be rated for accurate results.

Framework

The goal is to estimate the rating of a target user for a target item.

To estimate the rating, the system utilizes ratings from items strongly correlated with the target item (and the target user), and users strongly correlated with the target user (and the target item), as well as ratings from user-item pairs where neither the user nor item is the target but where both the user is strongly correlated with the target user and the item is strongly correlated with the target item. The correlated pair without either target provides accurate results by using the multiplication of the weight of the user of the pair with the target user, times the weight of the item of the pair and the target item.

Furthermore, the neighborhood is created using the largest correlation values in terms of absolute value, such that large negative and positive correlations are used. As such, neighborhood items are also called predictive items, and neighborhood users are also called predictive users, rather than similar items or similar users, since they may be related or opposite. In other words, knowing a rating of a user that is opposite of the target user's taste or a rating of an item that is opposite of the target item's preferred users are both useful in estimating the rating. By using the largest correlation in terms of absolute value, the strongest predictive items and/or users are utilized, not ignored, thus reducing error. The results are accurate since local residual ratings are used, and the magnitude and sign of the weight is used to properly add or subtract the residual rating.

In addition, care must be taken since, for highly correlated user or item pairs, the ratings are not identical, but only predictive. For example, if Pearson coefficients are used as the basis for the weights, the ratings for user or item pairs are linear, but can occur with an offset (i.e. residual). In other words, a Pearson correlation calculation ignores the offset by removing the local average. As such, local residual ratings (referred to as residual ratings from here on) are used. Residual ratings are ratings with the local average removed, and local is defined as where there is overlap in the sparse data. Specifically, for item-item pairs, the local item average rating is calculated using only users that have rated both items. For user-user pairs, the local user average is calculated using on items that have been rated by both users. Thus, the local average depends upon both items or both users in the pair. Local averages are more accurate than double centering with global item and user averages since they match the stats used to create the correlation coefficient. Finally, residual ratings have their sign changed for negative correlations, after centering (i.e. removing the average).

More specifically, the algorithms utilizes the following three aspects to predict the target user rating of the target item: (i) the target user's residual rating of predictive items, (i) the predictive users' residual ratings of target items, and (iii) the predictive user's residual ratings of predictive items. Thus, for (i), each predictive item's local average is removed from the rating to create the residual rating. Thus, for (ii), each predictive user's local average is removed from the rating to create the residual rating. Thus, for (iii), both the local item average and local user average are subtracted from the rating. These elements are weighted based upon the correlation coefficients, such that (i) is multiplied by a weight based upon the correlation of the predictive item and target item, (ii) is multiplied by a weight based upon the correlation of the predictive user and target user, and (iii) is multiplied by a combined weight based upon the correlation weight between the target and predictive item and the correlation weight between the target and predictive user.

This simple example demonstrates the importance of residual ratings, the target user rates every item with a 4, and a neighbor user rates every item with a 3. As such, there's a perfect correlation between the users. However, the neighbor's rating cannot be used directly as the estimate, but the offset (i.e. residual) is used. Thus, the estimate for the target item that the neighbor rated as a 3, is the target user average of 4, plus the neighbor's rating of 3 minus the neighbor's average of 3 (i.e. 0 for the residual), which is a 4, as expected. This example can equivalently be applied to items rather than users.

In a slightly more complex example provided to clarify the negative correlations and residual ratings, the target user and neighbor user are perfectly anti-correlated, with a Pearson coefficient of −1. The target's local average, items that both the target and neighbor users have rated, is 4, and the neighbor's local average is 3. The neighbor user rated the target item as a 4. The estimate for the target user-item pair is the target user average of 4 minus (due to the negative correlation) the residual rating of 1 (which is the neighbor's rating of 4 minus the neighbor's average of 3), resulting in a 3. In other words, the neighbor user thought the item was 1 better than average, so the target user should believe that the item is 1 worse than average. This example can equivalently be applied to items rather than users.

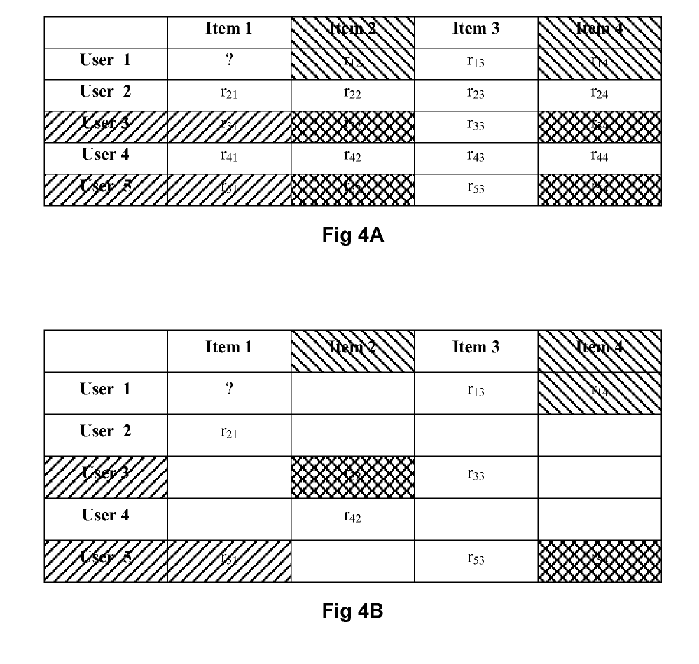

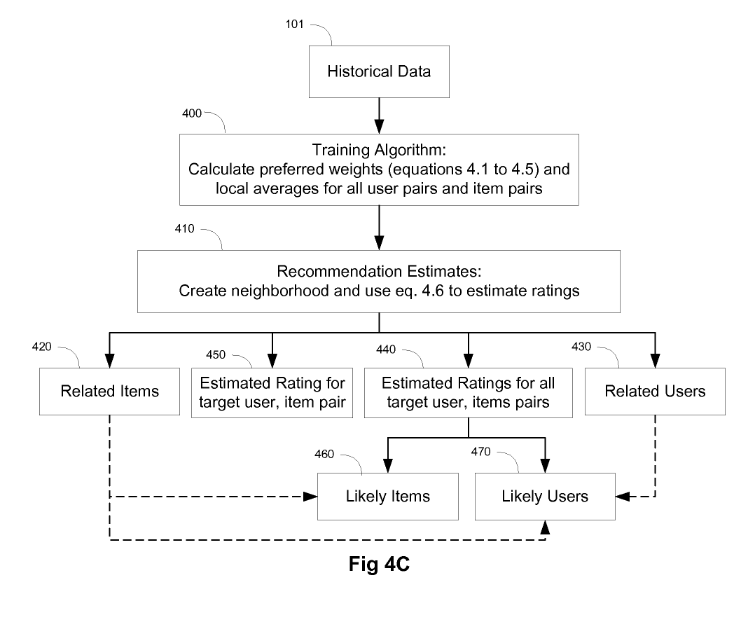

Another simple example is shown in FIG. 4A to demonstrate the creation of the neighborhood. In this very simple example, there are 5 users, 4 items, (1, 1) is the target rating, odd users are predictive with user 1 and even items are predictive with item 1. Thus, users 3 and 5 are predictive for target user 1, and shown with up diagonal cross-hatches. Items 2 and 4 are predictive with target item 1, and shown with down diagonal cross-hatches. User-item pairs (3,2), (3,4), (5,2) and (5,4) are also very predictive for user-item pair (1,1), and shown with both up and down cross-hatches (a.k.a. trellis). The prediction for user-item pair (1,1) now has more possibilities for an accurate estimate.

For example 1, it is assumed that user 3 and item 2 are both very predictive, with weights around 0.9, whereas user 5 and item 4 are weak with weights around 0.3. Thus, the expected prediction power of user 3, item 2 is 0.81(=0.9*0.9), user-item pair (3,4) is 0.27, user-item pair (5,2) is 0.27 and user-item pair (5,4) is 0.09. To this end, using user 3, item 2, and user-item pair (3,2) for the prediction is the most accurate 3 neighbor predictions (i.e. K=3, for this simple case).

Extending this neighborhood concept to sparse real-world data, where all the users have not rated all of the items, is shown in FIG. 4B. In this case, user-item pairs without ratings are ignored from the potential neighborhood, as shown without cross-hatches. Using the example 1 weights, the best neighborhood of K=3 is user 5, item 4 and user-item pair (3,2), where pair (3,2)'s weight of 0.81 is much more predictive than user 5's or item 4's weight of 0.3. This is obviously an improvement of an estimate based upon only related users or related items.

This concept is extended to real-world cases with the algorithm described below and shown in FIG. 4C.

Training and Recommendation Rating Estimates

For correlation-based estimated ratings, the training algorithm 400 calculates the item-item correlations, user-user correlations, and local averages and saves them. The recommendation algorithm 410 creates the neighborhood for the target user-item pair, and then estimates the ratings from the neighborhood.

Definitions

Let's begin with definitions.

Users=>1 . . . C where
c is the neighbor user
d is the target user

Items=>1 . . . M where
m is the neighbor item
n is the target item

Users are rows and Items are columns, thus:

Ratings (R)
R₀ is the baseline estimate
R_{cm} is a rating
R_{dn} is the target estimate rating (i.e. target user's estimated rating of the target item)

Correlation or weights (w)
w₀ is the baseline weight
w_{cd} is the preferred weight of a neighbor and target user (a.k.a. user pair correlation)
wₘₙ the preferred weight of a neighbor and target item (a.k.a. item pair correlation)

Local Averages
u_{cd} is the average of neighbor user c for user pair (c,d)
u_{dc} is the average of target user d for user pair (c,d)
Uₘₙ is the average for neighbor item m for item pair (m,n)
uₙₘ is the average for target item n for item pair (m,n)

Neighborhoods
N(d) is the neighborhood of predictive users for the target user d
N(n) is the neighborhood of predictive items for target item n

Training Algorithm 400

The weights are calculated as correlations between the target item and each other item (i.e. potential neighbor items), and the target user and each other user (i.e. potential neighbor users). Ideally, every item pair's and every user pair's correlation are calculated and saved to one or more files during training. Since most correlations are symmetric, in that the correlation between object 1 and object 2 is the same as object 2 and object 1, only the upper right hand of the 2D matrixes of item-item pairs and user-user pairs need to be calculated and saved. As an aside, this requires N*(N−1)/2 calculations where N is the number of items or users. Potential types of correlation include Pearson, Kendall Tau, Cosine similarity, or Spearmen, and these are all symmetric. Furthermore, Euclidean distance can be used on raw or double centered data, and the smallest distance is chosen, and noting that there are no negative Euclidean distances, so absolute values are not required. Pearson is preferred for estimating ratings as it determines the linearity between objects, and the more linear the predictive neighbor, the better the estimate since the recommendation algorithm is linear.

In the preferred embodiment, rather than directly using the Pearson correlation coefficient (w^{cc}) as the weights, a preferred weight (w) is used. The preferred weight is scaled by the multiplication of the log of the number of common ratings (N_{c}) times the lower bound of the 95% confidence interval of correlation coefficient (w^{ci}) squared. The confidence interval is calculated using the Fisher transform (w^{f}) subtracting 1.6 standard deviations (SD) in the Fisher domain for positive correlation and adding 1.6 SD for negative correlation (w^{sd}), and using the inverse Fisher transform (w^{s}). Thus, the preferred weight is calculated in the equations:

Fisher Transform: w_{f}=½*log((1+w^{cc})/(1−w^{cc})) [4.1]

SD: w^{sd}=w^{f}−sign(w)*1.96/sqrt(N_{c}−3); where sqrt is the square root [4.2]

Inverse Fisher Transform: w^{ci}=(exp(2*w^{sd})−1)/(exp(2*w^{sd})+1) [4.3]

Preferred weight: w=w^{ci}*w^{ci}*log(N_{c}) [4.4]

In addition, a sigmoid, such as equation 2.1, can be used on the final weight, such that it always remains less than 1, and the affect of the number of ratings is still applicable but reduced in magnitude.

The local averages are also calculated for each item-item pair and each user-user pair.

In the preferred embodiment, the preferred weights and local averages are saved in several files by row, and the full 2D matrix is saved. In other words, all correlations pairs are saved in each row, such that correlations are repeated. This is done since disk space is cheap, and enables the recommendation algorithm to read fewer files. The upper half can be saved if disk space is at a premium.

Recommendation Estimates 410

The most predictive neighborhood is found, consisting of the largest K (usually 10-50) absolute values of all of the preferred weights derived from the correlation of the target item with each item (i.e. potential neighbor item) acted-upon by the target user (wₘₙ), and the correlation of the target user with each user (potential neighbor user) that also acted upon the target item (w_{cd}), as well as the combination weights (wₘₙ*w^{cd}). The combinations weight is defined as, for each user-item rating, the preferred weight derived from the correlation of the target item with the item times the preferred weight derived from the correlation of the target user with the user. As a reminder, neighborhood items and users are also known as predictive items and predictive users, respectively.

In the preferred embodiment, the most predictive neighborhood is found in multiple steps. In addition, the term magnitude is identical to absolute value and is used to simplify reading. First, predictive users and predictive items are found that fill the neighborhood. Second, the smallest preferred weight magnitude in the neighborhood is used as a threshold. Third, only users and items with a preferred weight magnitude above that threshold are used in calculating the combination weight. Fourth, the combination weight is checked to see if it is larger than the smallest magnitude in the neighborhood, and if so, is added to the neighborhood (by order of its weight magnitude) and the smallest magnitude is dropped to keep the neighborhood size constant. Optionally, the threshold can be update at this time to the new smallest magnitude. Note that the smallest value may be a user preferred weight, item preferred weight or combination weight, after the first combination weight is added.

Once the neighborhood is found, the estimate can be calculated. The preferred embodiment includes a baseline estimate. In essence, the baseline estimate (R₀) is the sum of item ratings (sₙ) and sum of user ratings (s_{d}), adjusted by global average (u) and scaled by the number of actions upon the item (Nₙ), user (N_{d}) and threshold A (usually 10). The equation for the baseline estimate is:

R₀=(A*u+sₙ)/(A+Nₙ)+(A*u+s_{d}))/(A+N_{d})−u [4.5]

The baseline estimate is weighted (w₀) by 1 or the log of a minimum number of common actions required for a pair to be included in the predictive neighborhood. The baseline estimate times the baseline weight is included in the numerator. The baseline weight is also included in the denominator. Alternatively, the baseline estimate is only used if there are no neighbors or a minimum number, such as less than 5.

R_{dn}←(w₀*R₀+Σ|w_{cd}|*(u_{dc}+sign(w_{cd})*(R_{cn}−μ_{cd})) for c ε N(d)+Σ|wₘₙ|*(uₙₘ+sign(wₘₙ)*(R_{dm}−μₘₙ)) for m ε N(n)+Σρ|w_{cd}*wₘₙ|*(u_{dc}+uₙₘ+sign(w_{cd}*wₘₙ)*(R_{cm}−u_{cd}−uₘₙ)) for c ε N(d) and m ε N(n))/(w₀+Σ|w_{cd}| for c ε N(d)+Σ|wₘₙ| for m ε N(n)+ΣΣ|w_{cd}*wₘₙ| for c ε N(d) and m ε N(n)) [4.6]

Alternatively, the combination weighted rating estimate in the numerator can be replaced by non-symmetric estimates of eq. 4.7 or eq. 4.8, and the denominator is unchanged. Equation 4.7 first estimates the target user-predictive item rating, then estimates the target user-item pair:

ΣΣ|wₘₙ|*(uₙₘ+sign(wₘₙ)*(|w_{cd}|*(u_{dc}+sign(w_{cd})*(R_{cm}−u_{cm}))−uₘₙ)

for c ε N(d) and m ε N(n) [4.7]

Equation 4.8 first estimates the target item-predictive movie rating, then estimates the target user-item pair.

ΣΣ|w_{cd}|*(u_{dc}+sign(w_{cd})*(|wₘₙ|*(uₘₙ+sign(wₘₙ)*(R_{cm}−uₘₙ))−u_{cd})

for c ε N(d) and m ε N(n) [4.8]

This algorithm can also be used with positive weights only, and is still much more effective than using only related items or related users.

Koren and Bell (references in background section) use double centering. However, this is not necessary with using local averages and residual ratings since they are accounting for item or user offsets more accurately than centering based upon the global item and user average.

Related and Likely Recommendations (420 to 470)

Related items 420 and related users 430 are derived as the largest positive correlations from the item-item pair correlations and user-user pair correlations calculated during training, respectively. Estimates optimally use Pearson due to linearity. As such, related items and users use Pearson. However, it is believed that a non-parametric method, such as Kendall Tau or Spearman, may be better for related items, but this is more complex since it requires additional computation.

The estimates can be the output of the algorithm (box 450), or they can be used to find likely items 460 and/or likely users 470. For likely items, for a user, every item's estimate (excluding items rated by the user for use-once) can be calculated (box 440), and the largest are the likely items 460 to be acted upon by that user. If an item is categorized (or inherently assumed) as re-use, this previously rated items should be compared to the estimates to be entered into the likely items 460. The actual or estimate rating can be used for the comparison.

In related fashion, for an item, every user's estimate can be calculated (box 450), and the largest are selected as the likely users 470 to act upon that item. If the item is categorized (or inherently assumed) as re-use, users whom have already rated that item should have the actual rating or estimated rating compared to the estimates to become part of the likely users 470.

Alternatively, the related items 420 could be used to determine the likely items 460 and likely users as described in section 3, and shown as an optional dashed line in FIG. 4C. The related users 430 could be used to determine the likely users 470 as describe in section 3 and shown as an optional dashed line in FIG. 4C.

5. Matrix Simplification for Related Items and Users, and Likely Items and Users

SVD and Matrix Simplification Overview

Singular value decomposition (SVD) is a mathematical method that converts an original matrix of into three derived matrices, which when multiplied produces the original matrix. One derived matrix has singular values (traditionally the matrix in the middle, or second derived matrix). If only the largest few singular values are kept, the three derived matrices can be simplified by removing the rows and columns negated by removal of the smaller singular values, resulting in three simplified matrices that when multiplied estimate the original matrix. This simpler singular value matrix can be multiplied into the other two (end matrices) resulting in two simplified small matrices that estimate the original matrix. The estimate is very accurate since the largest singular values were kept.

SVD is related to principal component analysis, Eigenvalue decomposition, matrix decomposition or matrix factorization (e.g LU Decomposition)—all labeled matrix simplification methods in this application. The implementation in this patent application has been labeled SVD by the market, but is applicable to any of these matrix simplification methods. In addition, it is related to the Korbell IncFctr algorithm in “The BellKor solution to the Netflix Prize” and “Modeling Relationships at Multiple Scales to Improve Accuracy of Large Recommender Systems”, already referenced in the background and included by reference).

If the original matrix is m items by n users, then the resulting two simplified smaller matrices are m items by f features and n users by f features. An estimate of the original matrix is taken by multiplying the two matrices, with the second matrix transposed—which is mathematically equivalent to estimating an item user pair by multiplying item features by the user features.

Recommendation System Overview

Matrix simplification methods are very complex and require software to implement them. Furthermore, most algorithms require a complete input (i.e. historical data) matrix. Yet, this data is sparse with missing entries, which are the user-item pairs to be estimated.

The matrix simplification methods have two advantages when compared to correlation based systems, including:

1. Potentially recommends new items that has a few actions

2. Estimated ratings are extremely simple to calculate after training creates the features

The related items and related users are based upon correlation of the item and user features, respectively. The simplest correlation method is Pearson correlation, which finds the linearity between the features for each item or user—and its calculation is well known in the state of the art. Other correlations can be used. As the closeness between two item's features is desired over linearity, correlations measuring distance or rank can be better. Kendall-Tau rank correlation can be used since it is a non-parametric statistic used to measure the similarities. For both Pearson and Kendall-Tau, the outputs are between −1 and 1, and the positive correlations times 100 can be interpreted as percent similarity.

Furthermore, Euclid distance can be used. It includes summing the square of the difference between each item's or user's feature for each feature index, and then taking the square root of the sum. For Euclid distance, the smallest coefficients are saved since these are the most related, and the similarity is 100−c1*(the Euclid distance−c2), where the factors are calculated to scale the items to an intuitive feel of similarity. One example is to choose the c2 factor as the smallest Euclid distance and c1 such that the largest distance results in 50% similarity. Euclid distance is also known as an L2 norm, and other distances or norms, such as summing absolute values can similarly be used.

The likely items and users are based on estimated ratings, as discussed below. They can also be determined using the related items and users found from matrix simplification, using the methods described in earlier sections.

Training Algorithm Architecture

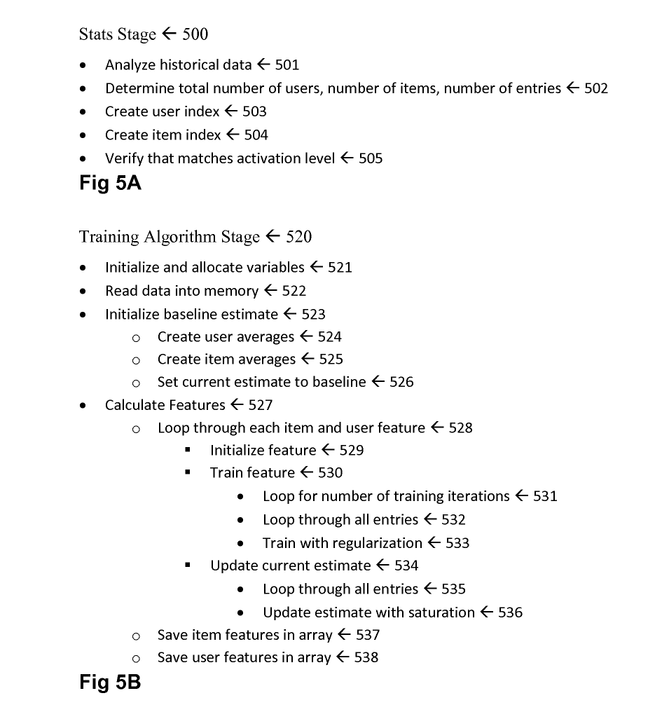

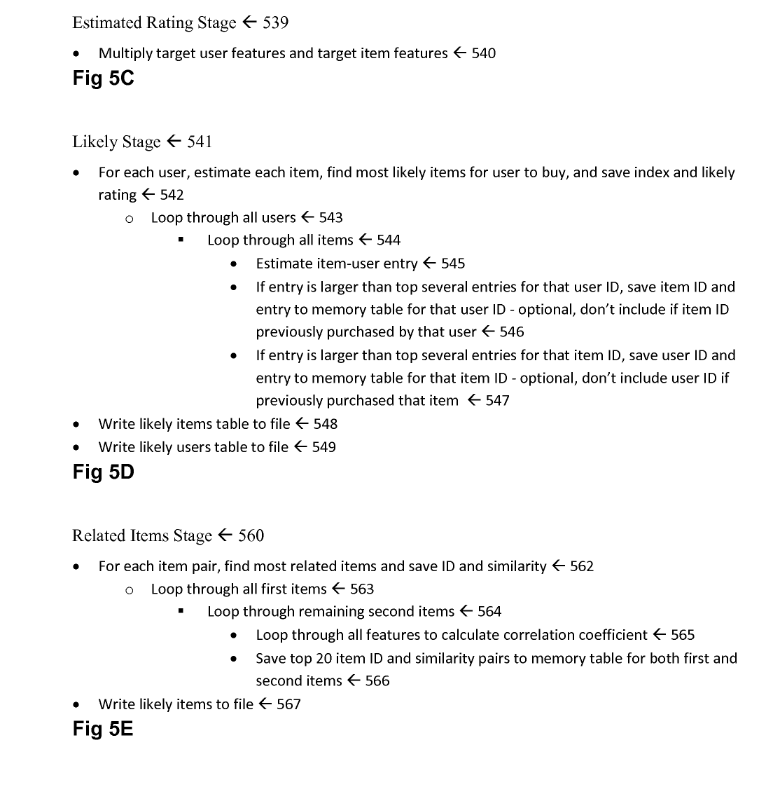

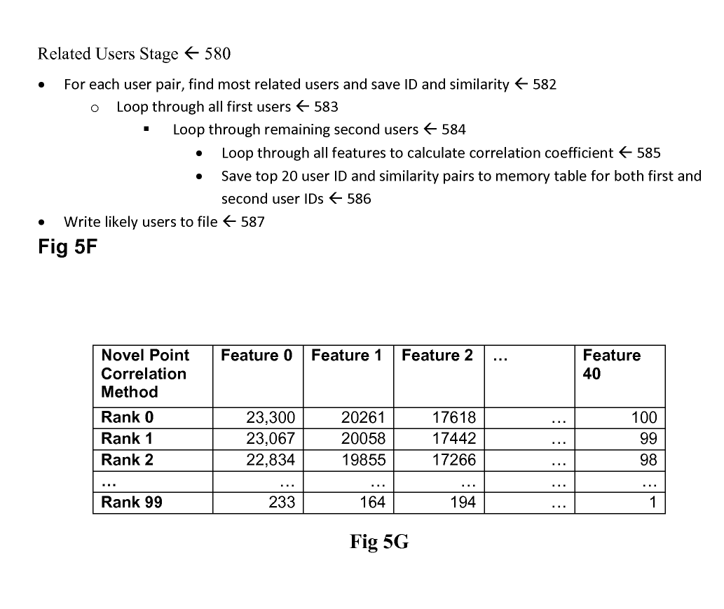

The architecture of the training algorithm is shown in FIGS. 5A through F. It includes five stages. The stats stage 500 analyzes all of the historical entries, and determines the stats so that dynamic arrays can be allocated in the remaining passes. The training algorithm stage 520 performs the training. The estimated rating stage 539 estimates the ratings for target item, target user pairs. The likely stage 541 determines the likely items for each user and likely users for each item by looping through each user-item pair, estimating the value and organizing them into the 10-20 most likely to purchase items for each user, and most likely to purchase users for each item. The related items stage 560 determines the related items by looping through each item pair and then the looping the item features to calculate correlation coefficients, and organize them into 10-20 most related items for each item. The related users stage 580 determines the related users by looping through each user pair and then the looping the user features to calculate the correlation coefficients and organize them into 10-20 most related users for each user.

The stages can all be used together, or alone to create a system. For example, the related users or likely users (for a given item) may not be used by some systems. The important details of each stage are discussed below, and some details such as initialize variables, delete arrays, and set or verify activation level, are shown just for completeness. As stated, the system is usually implemented as an offline program, such as Windows software, but the system can be run on any OS, and online or offline.

Stats Stage 500

In this stage, the historic data is analyzed (step 501), the total number of users, number of items, number of entries are determined (step 502), the user index (step 503) and item index (step 504) are created, and finally the activation level is verified (step 505).

When obtaining data directly from the database, the user index (step 503) and item index (step 504) are not needed since the database most likely includes primary keys for them.

Training Algorithm Stage 520

The number of items, users and entries were determined in step 502 so that arrays can be dynamically allocated (step 521 and 522) for holding the historical data, training the features, and calculating recommendations (i.e. related items, related users, likely items and likely users).

In programming terms, the item is represented by i, the user by j, and feature by k. For the historical data, the row i and column j of the input array, x, is defined as x[i][j] and has the entry for the user-item pair purchase, play and/or view. The item feature matrix, p, has entry p[i][k] with the k feature value for the i^{th} item. Equivalently, the user feature matrix, c, has entry c[j][k] with the k feature value for the j^{th} user. These arrays are initialized and data loaded in steps 521 and 522.

The solution proposed by Funk uses iterative training via gradient descent, and is very similar to training neural networks. It is fully described in his references, Timely Development reference and John Moe reference (all previously included by reference). Our preferred algorithm is implemented with the better mean for baseline estimates including item and user means (steps 523-526), regularization to minimize over fitting (step 533), and simple saturation for non-linear output curves when updating current estimates (steps 534-536). The algorithm can be improved with non-linearity, but it is not clear whether than generalizes to all data sets.

The algorithm uses the following constants:

| | | |
|---|---|---|
| #define INIT | 0.1 | // Initialization value for features (step 529) |

| | |
|---|---|
| #define LRATE 0.001 | // Learning rate parameter |

| | | |
|---|---|---|
| #define A | 10 | // For better mean for baseline estimate (a.k.a. K) |

| | | |
|---|---|---|
| #define K | 0.02 | // Regularization parameter, minimize over-fitting |

| | |
|---|---|
| #define ITERS 120 | // Number of iterations of training for each feature |

#define NUM_FEATURES 80 // Usually between 40 and 80

The c-code for the core algorithm is below, and this is called after the memory is allocated and initialized:

for (k=0; k<NUM_FEATURES; k++)
{

// == Initialize Features ==
for (i=0; i<m_numUsers; i++) userFeature[i] = INIT;
for (i=0; i<m_numItems; i++) itemFeature[i] = INIT;
// == Train a feature ==
// Loop through iterations - end on loop count or error
for (j=0; j<ITERS; j++)
{

// Loop through all entries
for (i=0; i<m_numEntries; i++)
{

itemFeatureOld = itemFeature[ itemIndex[i] ];
userFeatureOld =userFeature[ userIndex[i] ];
currEst = currEst[i] + ( userFeatureOld * itemFeatureOld );
err = LRATE * ( rating[i] − currEst );
userFeature[ userIndex[i] ] += err * itemFeatureOld − K * LRATE * userFeatureOld;
itemFeature[ itemIndex[i] ] += err*userFeatureOld − K * LRATE * itemFeatureOld;

} // end for i = 0 to numEntries

} // end for j = 0 to ITERS
// == Update current estimate in SVDData ==
// Loop through all entries
for (i=0; i<m_numEntries; i++)
{

```
  currEst[i] += userFeature[ userIndex[i] ] * itemFeature[ itemIndex[i] ];
  // Saturation
  if ( currEst[i] > MAX_RATING) currEst[i] = MAX_RATING;
  else if (currEst[i] < MIN_RATING) currEst[i] = MIN_RATING;
```

} // end for i = 0 to numEntries for updating current estimate
// == Write Features to Disk ==
WriteFeature(pafItemFeature, pafUserFeature);

} // end for k = 0 to NUM_FEATURES

Most variables are self-explanatory, using camelCase. numEntries is the number of training data entries. currEst is the cached current estimate for all training data entries. It begins with the baseline estimate (equation 4.5), and then maintains the current estimate for the previously finished features.

The direct output of the matrix simplification of the historical data is the item and user feature matrices (steps 537 and 538). In our preferred embodiment, we use 40 features. Increased accuracy will occur with more features, at the cost of increased training time and RAM usage. However, estimate improvements tend to tail off around 40 features, so 40 is chosen.

Thus, in the preferred embodiment, the output is two tables (as memory arrays or files). An item table of dimensions number of items by 40 features, and a user table of dimension of number of user by 40 features. The user and item averages (steps 524 and 525) also must be included to determine the baseline estimate.

Estimated Rating Stage 539

The estimate for a target user-item pair is the multiplication of the item features by the user features (step 540). The complete estimate matrix can be created by multiplying the item table by the transpose of the user table (or user table by the transpose of the item table).

As an aside, accuracy can be determined by comparing the estimates for user-item pairs that had entries in the historical data. Furthermore, some of the historical data can be kept out of the simplification process (a.k.a. training), and then compared to the estimates. A good option is to test accuracy with the most recent historical data.

Likely Stage 541

In the program, this is done by looping through all user-item pairs and calculating the estimate (steps 542-547). For each user, the largest estimates and item IDs are saved in the likely item table (step 546), and written to a file when completed (step 548). Usually 10 to 20 estimates are stored such that each user has 10-20 likely items and probabilities. For each item, the largest estimates and user IDs are saved in the likely user table (step 547) and written to a file when completed (step 549). Usually 10 to 20 estimates are stored such that each item has 10-20 likely user and probabilities. The estimates are used to predict the probability of purchase for the user-item pair. Furthermore, thousands of users could be saved for each item ID, one item ID, or a limited list of item IDs, as possibly desired for an email blast.

If the goal is to understand the likely items for a few users, the estimates only need to be calculated for all of the items for those few users. However, all of the historical data needs to be used for training. In other words, the estimates for every user-item pair don't always need to be calculated. The equivalent is true for likely users, where only the estimates need to be calculated for all of the users for those few items.

Furthermore, if larger numbers are not chosen as more preferable in the historical action data, but smaller numbers refer to actions, then the estimates are interpreted with smaller number as more probably to cause action. However, choosing 0-1 to match standard probability or 1-5 with 5 as the best rating is common and intuitive to understand.

Alternatively, as fully discussed in section 2, subsection recommendation data 112 and section 3, the related items can be used to create the likely items, and related users can be used to create the likely users.

Related Items Stage 560

To find related items, for every item pair, excluding pairing an item with itself, the two item feature vectors are correlated (steps 562-566). For each item, the largest correlation coefficients are stored in a related item table (step 566), and written to a file when completed (step 567). Usually 10-20 related items are stored such that each target item has 10-20 related items and similarity correlations.

It is important to note that related items aren't always bought together. When often bought together, the items are likely to have related features, and thus be identified as related items. However, related items can also have been purchased one at a time by related users—since related users have related features, the items can have related features and be identified as related items. This is true for played, rated and/or viewed data.

If only related items are desired for a few items, then only the correlation of the item features for the few items with every other item's features is needed. This is much less computation than the correlation of every item features with every other item features. However, the training needs to use all of the historical data. The equivalent is true for related users, where only the correlation of the few desired users with every other user is needed.

Related Users Stage 580

Equivalently, to find related users, for every unique user pair, the two user feature vectors are correlated (steps 582-586). For each user, the largest correlation coefficients are stored in a related user table (step 586), and written to a file when completed (step 587)—usually 10 to 20 coefficients for each user. By the equivalent logic as used for related items, related users don't have to have bought the same items, but could have bought related items—so the users have related features.

Feature Contributions

When using gradient descent or related learning, the features improve the accuracy of the estimates less with each feature. As such, the lower the feature index, the more important to the estimate. We find that a weighting of 0.87 matches the experimental data, where each feature contributes 0.87 less improvement to the estimate. In other words, the increase in accuracy of the estimate for feature 2 is 0.87 times the increase in accuracy for feature 1—on average.

To this end, the features can be weighted with decreasing weight for the higher feature index in the calculation of the correlation coefficient. For feature index k (starting with feature index 0), an exemplar weight is 0.87^{k}, or, equivalently, 1/(1.15^{k}). Weighting is difficult with Pearson since it measures linearity, and actually can remove non-linearity in the data. For Euclid each feature's difference can easily be weighted by 0.87^{k}, preferably before squaring.

Scaled, Ranking Points Method to Correlate Feature Vectors

A novel ranking method can be used to correlate feature vectors. This method ranks the items or users for a target item or user, respectively, in terms of difference between each item's or user's feature and only keeps the top 100, rank 0 to 99. It does this for each feature index, e.g. k=0 to 39 (for 40 features). points for each ranking. The number of points, and spread between points, both decrease for higher feature indexes. More specifically, as shown in FIG. 5G:
For k=0, rank 0 (i.e. best match) gets 23,300(=100*1.15̂39) points, and each successive 233(=1.15̂39) less points—such that the change is 233
For k=1, divide highest number of points and change by 1.15, such that rank 0 gets 20261 points and each successive ranking gets 203 less points
For k=39, highest number of points is 100 (26800/1.15̂39) and change is 1 (233/1.15̂39), such that rank 0 gets 100 points and each successive ranking gets 1 less points

It does this for each target item or user, such that each item or user has the list of related items or users, respectively. It could do this for each pair, and result in the list of most related pairs across all items.

For this method, the desired affect that the first feature index is most important, second feature index is next most important is upheld, as shown in this example
Item pair (a, b) has its first feature as the most related and second feature as second most related=26,800+23,071=49,871/50104=99.53%
Item pair (a, c) has its first feature as second most related and second feature as first most related=26532+23,304=49,836/50104=99.47%

As desired, the item pair that is 1^{st} for the first feature index obtains the highest score, even though both pairs have a first and second place.

The final points for each item pair is totaled across all feature indexes and divided by the potential total (if the same pair always had rank 1) of 177,964. The resulting coefficient is interpreted as percent similarity and used in finding the top 10-20 related items for each item (or related users for each user).

The highest number of points doesn't need to decrease, but the difference does need to decrease as the feature index increases. As such, the highest number of point could be 26,800 each time, and the decrease per feature index is as defined above, such as 233 for feature 0, 203 for feature 1, and so on. This still produces the desired results of having the first feature index have the most affect. Furthermore, the highest number of points could be below 26,800, such that not all 100 ranks receive points for the first several feature indexes—where the number of ranks not receiving points depends upon how far below 26,800 the highest points is chosen and if a different decrease is chosen, the amount of decrease.

Finally, the number of feature indexes and decrease factor (e.g. 1.15) can easily be changed and the above system works with adjusted highest points and decrease factors as easily determined by a person familiar with the state of the art given the description above.

Memory Usage

Training memory usage with 10 recommendations for 100K historical entries with 10k items and 50k users Historical array=2.0 MB

=100K entries*(4B for entry+4B for user index+4B for item index+and 8B for estimate)=100K*20 Bytes

Item Features=1.6 MB

=40 features*10,000 items*4B for feature value

User Features=7.6 MB

=40 features*50,000 items*4B for feature value

Related Items and Likely Users, each=840 KB

=10,000 items*(4B for item ID+10 recommendations*(4B for related item ID+4B for similarity))

Related Users and Likely Items, each=4.0 MB

=50,000 users*(4B for user ID+10 recommendations*(4B for related user ID+4B for similarity))

Memory usage for historical data can be reduced by using words (2 bytes) for indexes, assuming less than 16k, unsigned char (1B) for ratings, and unsigned words (2 bytes) for estimates where the number is scaled by 10000 to represent decimals accurate to 4 decimal places. This is applicable to all training algorithms in this application, and used in section 6 for matrix simplification dislike training. It is critical when using a 32 bit OS and 100 million historical data entries.

Recommendation memory usage is the sum as the last two groups of arrays and discussed in section 2, subsection memory usage and multiple clients on one PC.

6. Matrix Simplification for Non-Rated Data

Matrix simplification fails for non-rated data, as the features just become the value used to represent the action, e.g. 1 if a purchase is represented by a 1. Or, if residual data is used, all the features become a 0 since the average is the same as each entry. Matrix simplification needs entries with different values, preferably where one value represents a like and one value represents a dislike, to work. For example, with ratings data of 1-5, 1 and 2's can be represented by 1—and 3, 4 and 5 can be represented by a 5, and the results of the recommendations of related items or users is reasonably accurate. Similarly, if entries are between 0.8 and 1 to represent repeat usage, the training converges to an estimate of the number of actions as opposed to like or dislike.

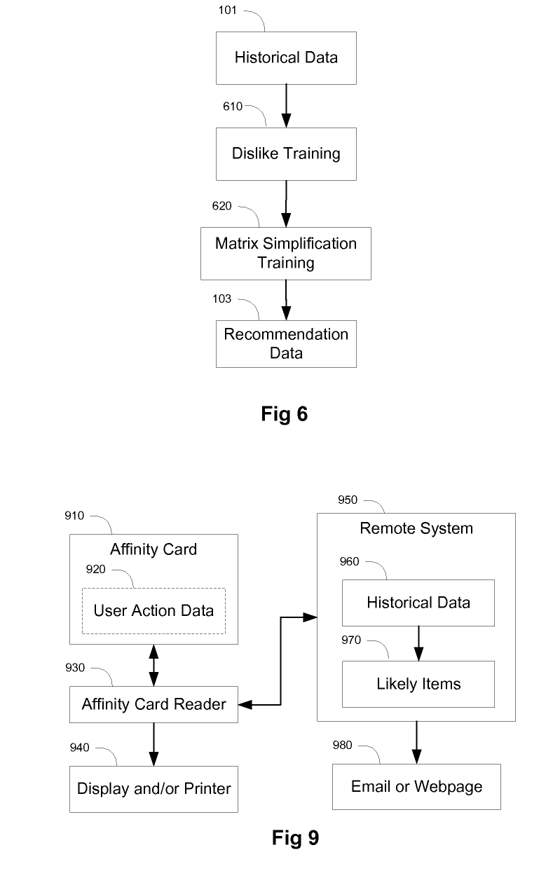

As shown in FIG. 6, to use matrix simplification for non-rated data, a step of dislike training 610 is included before matrix simplification training 620, such as that of section 5. The final results are related items, related users, likely items, and/or likely users. The estimated rating can even be interpreted as probability of action. Any matrix simplification method existing in the prior art or developed in the future can be used. Non-rated data includes mostly non-rated data, where it is expected that at least ¼ of the data should be rated to use matrix simplification as described in section 5. Furthermore, returned items can be automatically used as dislikes.

The dislike training 610 finds items that the user will mostly not act upon, and gives them a bad value, such as a 0 where a 1 represents an action. The number of dislike user-item pairs (labeled dislikes) can be equal to the number of acted upon items. Psychologically, most people dislike fewer items that they like, and this concept can be used to set the number of dislike user-item pairs to ⅔^{rd} of the number of acted upon user-item pairs. Alternatively, more dislikes could be used. In addition, the number of dislikes can be distributed across items or users to match (possibly in a ⅔^{rd} ratio) the number of actions upon that item or by that user.

There are two methods of dislike training 610, correlation and matrix simplification.

Correlation for Dislike Training 610

One preferred method for using correlation to find dislikes is to use a correlation approach to find the similarity between all items, such as described in section 3. Then, for each user, the similarity between acted-upon items and other items is found for each acted-upon item. These similarities are combined for each acted-upon item by adding the similarities if an item is related to (i.e. has a significant similarity with) multiple acted upon items. Finally, for each user the items with least similarity are selected as dislikes, with the ratio between acted upon items and dislikes constant for all users, such as 1 or ⅔^{rd}. It's the opposite of the method to find likely items.

Alternatively, the smallest similarities across all users can be used as dislikes, or a combination of smallest for each user and all users.

In addition, the process can be done with related users, and users with the smallest similarity with users that acted upon the target item are used are the dislikes. Furthermore, this related user approach can be combined with the related items approach. Again, it's the opposite of the method to determine likely users.

Alternatively, the threshold approach described in the matrix simplification for dislike training subsection (next subsection) could be used to find dislikes from the correlations.

Once these dislikes are chosen and set to 0, and the acted-upon items set to 1 (or any numbers), the matrix simplification method can be applied, and related and likely items and users determined.

KNN and KFN Approach

The above method uses the similarity between each item and/or user. In some cases, such as for very, very large historical data (i.e. trillions of user-item pairs), only a specific number of nearest neighbors, i.e. KNN, are used to save space and time. The K nearest neighbors can be saved, and then, for each user, items that have no acted-upon related neighbors by that user, can be randomly chosen as dislikes.

Equivalently, K farthest neighbors (labeled as KFN and defined as smallest correlation, such that negative correlation is smaller than 0) can be used. In this case, K farthest neighbors are saved, and, for each user, least related neighbors of acted-upon items by that user, especially if an item is a least related neighbor of multiple acted-upon items, can be used as dislikes. For KFN, if an item-user pair was never included, it should not be used as a dislike because it can be a liked item.

Matrix Simplification for Dislike Training 610

Another preferred method involves setting all user-item pairs with no action data to 0 and representing user-item pairs with actions with a 1 (or any suitable number). Then, using any matrix simplification methods, the training is done on the whole data set. Since the data is not sparse, mathematical solutions can be used to solve, such as to find SVD, Principle Component analysis (PCA), or eigenvectors. Since the matrixes are large, an incremental method, like that of section 5, is preferred. However, due to the size of the input data (remembering that there will usually be many more non-acted upon items than acted upon items), fewer iterations and features are used, so that it finishes in a reasonable amount of time. In addition, when calculating the second or later feature, the affect of the previous features may not be able to be cached, as it takes too much memory, but re-calculated each time—which is slow.

After training, the items with the smallest estimates are considered the dislikes, and the related number of dislikes (Nd) as number of acted-upon items are represented as 0's, with the user-item pairs that were acted-upon represented by 1's.

The dislike items can be found by ordering all of the ratings, and choosing the lowest Nd. With historical data arrays (like billions) and numerous acted upon items (like 100's millions), this can be very slow. More preferably, the dislikes can be found as the smallest estimates over all items for each user, such that the ratio of dislikes to acted-upon items is constant for that user. In this case, ordering of lists can be used since the list and number of smallest items is fewer than for the global list.

Alternatively, random sampling can be used to find the very small values to be used as dislike items. Numerous methods can be used, and the preferred method is to start with a threshold of 0, methodically move through items, then users (or visa-versa), and find Nd estimates below the threshold. If this process takes at least a third of the items (or users) and finds Nd estimates below the threshold in all of the estimates, then the threshold is good. If it takes less than a third, the threshold is reduced by one standard deviation of the small estimates (only using estimates below 0.01 since the desire is to find the stats of the dislikes, not acted-upon pairs whose estimate should be near 1). If it does not complete after every estimate is compared, the threshold is increased by a standard deviation. If it takes less than a third, and then does not complete, the threshold is set at the previous value (i.e. threshold that takes less than a third). If it does not complete, then takes less than a third, the threshold is the current threshold (i.e. threshold that takes less than a third). The threshold starting point can be any value, and can use statistics, such as the estimate average minus two standard deviations.

If the statistics are accurate enough, the sampling of dislikes described in the previous paragraph can be skipped, and the statistical threshold used. However, it has been difficult to accurately determine the threshold with statistics, without some modification using the sampling of the previous paragraph.

After a threshold is found, user-item pairs are selected at random, and if the estimate is below the threshold, the item, user pair is a dislike and represented by 0.

Preferably, the method guarantees that most every item and user has a dislike. In this method, the first item and random users are selected, until a dislike is found or most users are evaluated. Then, the second item and random users, and so on for all items. Next, the first user and random items are selected, until a dislike is found or most items are evaluated. This is repeated for each user. Finally, random user-item pairs are selected, compared to the threshold until enough dislikes are found:

This method can easily be modified such that each item and user has multiple dislikes, or the same ratio of acted-upon items to dislike items for each user, or acting users to dislike users for each item (less preferable). The theory is that a more active user is more likely to find items that they dislike.

Another related embodiment of matrix simplification dislike training 610 randomly selects N user-item pairs to become 0, where N is the same as the number of actions. Then, the data is trained as discussed above, and a small portion of N is chosen as dislikes. The process is repeated numerous times. Optimally, each random user-item pair is checked to make sure it has not been acted-upon or previously used. However, this is not necessary, as the randomness will overcome the repetition.

The theory behind any matrix simplification approach is that an item-user pair that would be liked will have trouble remaining at 0 since related acted-upon items and related acted-upon users will be pulling its value up towards 1.

7. Social Networks and Recommendations

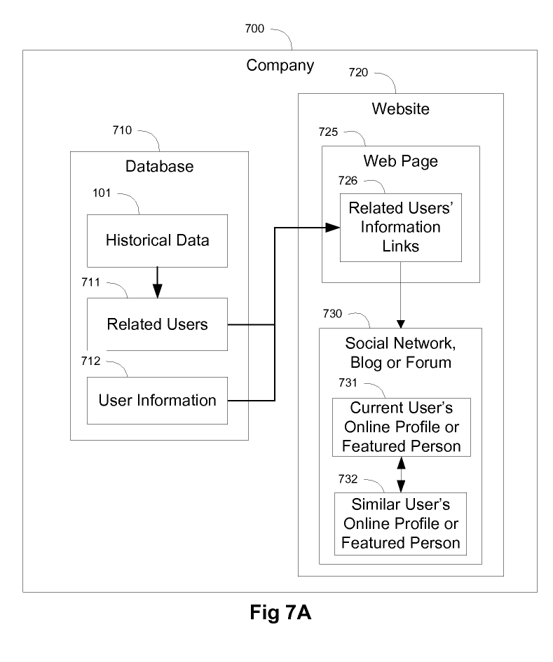

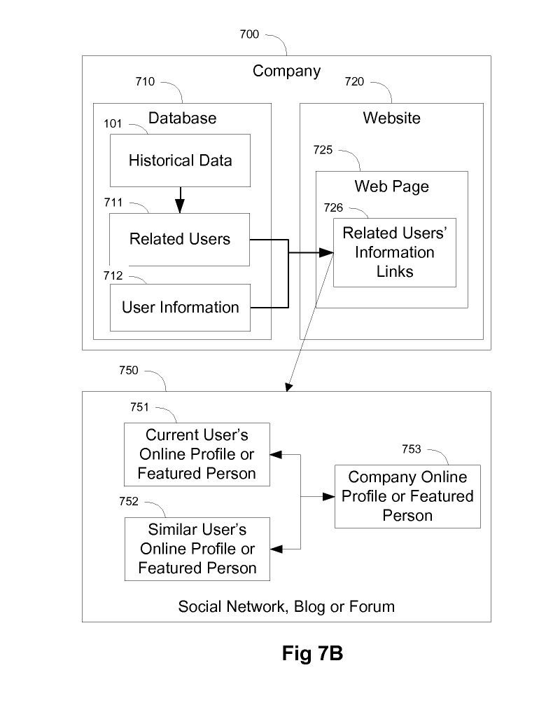

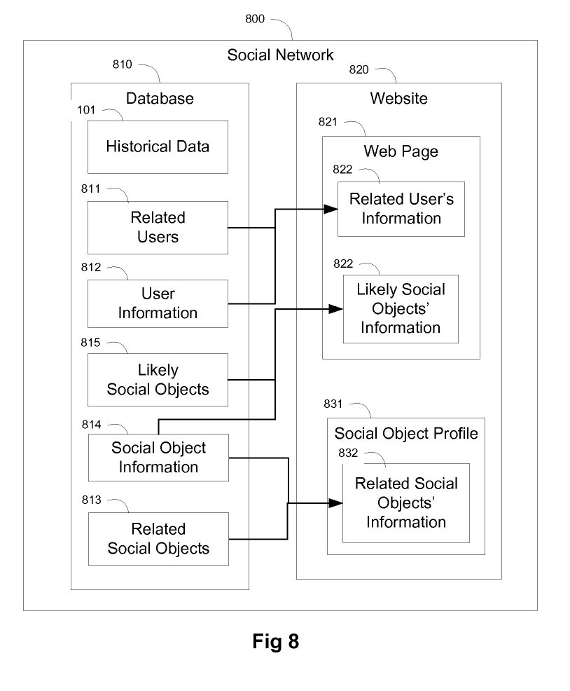

Showing users a list of related users opens social networking opportunities for websites, and can increase sales or traffic, as shown in FIGS. 7 and 8.

As background, there are numerous methods of calculating related users. They can be calculated by matrix simplification or correlation algorithm, as described in this application, or any other prior art or future invention. Simply finding user pairs that have both bought the most identical items can also be used. This involves adding a point to a user pair each time they have both bought the same item, and related users are the pairs with the most points. However, the method of sections 3 and 6 are preferred over this simple method for non-rated data, and methods of section 4 and 5 are preferred for rated data—due to the improved accuracy. A user can be a user of any webpage, although cookies or registration are needed to track the user's behavior to find related users, or a-registered user of e-commerce websites. Links or connections between users are also known as friends, favorite people, or favorite users, etc.

Related Users and Social Networks

As shown in FIG. 7A, the company 700 that owns the website and social network desires to link related users, has a database 710 that includes historical data 101, related users 711, and user information 712. Recommendation training on historical data 101 creates related users 711, and is done offline and periodically (daily to weekly). The user information 712 is the user registration and contact information, including name, address, email, text number, image, description, online profile link, and other standard elements.

When a current user is browsing the website 720, the web page 725 displays related users' information links 726. This information 726 provides a name, brief description and/or image of the related user, and is created by integrating the user information 712 with the related users 711, usually via the related user's ID. If the related user does not have an online profile on the social network, the related user is not be displayed—or the related user is displayed, and if selected, is sent a request to create an online profile, and then linked to the current user after the online profile is setup. This information 726 is displayed as links to connect the current user and related user.

After showing the current user the related users' information links 726 on a web page, the current user can click on a related user information link and be introduced. The current user can be shown the items that the related user has bought, viewed, played and/or rated—given the related user's permission for such actions. It is preferred that the introduction leads to an ongoing relationship between the users so they use the website more often and/or buy or rent more items.

The users can be linked via a forum or blog (including twitter.com) 730, such as making the both users become a featured or favorite person for each other (731 and 732), and see comments that the related user has made in the forum or blog 730. The forum can be on the client's website, enabling the current user to see a related user's comments. A user can be shown the related users ratings of items. In these cases, ratings and comments from a user with similar buying habits is most interesting.

Alternatively, the user is linked to the related user in a social network 730 so that the users are enabled to keep sharing information through the social network. It could be a proprietary social network 730, designed for the specific site that includes the related user's opinion on the website content and/or items purchased, rented, played, and/or viewed. The users have online profiles, the current user's online profile 731 and related user's online profile 732. The connection links their profiles and enables them to keep sharing information through the social network 730.

Another preferred embodiment is shown in FIG. 7B. In this case, the database 710 and website 720 are identical to FIG. 7A, except that the website 720 does not include a social network and the user information 712 includes links to an external social network, blog or forum 750. In this case, the website 720 enables the current user to connect to related users via existing social networks 750, such as MySpace and Facebook, or any existing forum or blog 750, such as twitter, blogspot or blogger.

Specifically, the current user's online profile 751 is linked to the related user's online profile 752, or the related user is enabled to setup a profile. It is preferred that the company 700 has a company online profile 753 on the social network 750, and the current user and related user are also linked to the company online profile 753. The company's social network profile could include promotions, ads, item description, etc. The goal is that the related users' continued use of the social network 750 and the company's online profile 752, such that the company 700 can increase traffic and/or sales.

Similarly, the users become featured or favorite users (751 and 752) for each other in the blog or forum. Again, ideally the company has a blog and it is also featured person 753 in each user's blog or forum.

Recommendations within Social Networks

The goal of social networks is to have their website used as much as possible, and by linking more people together as friends, and linking more people to items, such as groups that they like, the website will be used more. Recommendations based upon this application's algorithm or any other algorithm can be used to link related users and users to social objects that they'll enjoy.

Social objects are defined as friends, groups, and application features, in addition to items purchased, played, rated or viewed. The application features can include shared items, such as icons linked to the city that a user grew up in, or related music, or rating items purchased. The applications can be part of the social network, or 3^{rd} party applications using the social network's API.

Social objects are linked to users when a users purchases (e.g. bought or rented) items, played media, rates items (including songs and items), views web pages, invites to friends, joins a groups (including item pages, band pages, promotions, etc.), shares icons or images, and acts upon any other shared application feature.

For the recommendation algorithm, the users are represented by unique user IDs, and social objects are represented by social object IDs—where the IDs are usually converted to sequential integers by an index that connects the alphanumeric ID to the integer, as discussed in section 2. Thus, the historical data is represented by a matrix of users IDs by social objects IDs with entries for links between social objects and users. The historical data is usually stored as a compact list or relational database, rather than 2D matrix since it is so sparse, thus saving disk or memory space. The entries can be 2's for any item the user is linked to (e.g. included in their profile, wall or home page), acted upon, or the entry is the rating for rated social objects. Alternatively, the entries can determine their value via any method as described in the section 2, historical data subsection of this specification.

In the preferred embodiment, for a social network that does not contain ratings, the simplicity of an entry of 1 for links between a social object and user is preferred, since social objects are either linked or not, and cannot have multiple links to a user. For a social network with rated items, the non-rated link entry should be slightly greater than the average rating, such as a 4 with ratings between 1-5 where 1 is low and 5 is best.

Related Users within Social Networks

As shown in FIG. 8, the social network 800 has a database 810 with historical data 101, related users 811, and user information 812. The users can be identified as related users 811 by any recommendation algorithm.

Related users 811 and user information 812 can be combined to be displayed on the website 820 as related user's information 822. This information 822 is displayed to the current user on their social network web page 821 as potential people they might like to link to (a.k.a. become friends). They can be displayed alongside potential friends that live in the same city, went to the same school, work for the same company, etc. They can have information that says why they are related, such as including a list of shared groups, friends, application items, etc. For example, Tom can be listed as a potential friend and below Tom's name is the text that they have 24 friends in common, both share membership in 15 groups and both liked 28 of the same bands. The text can be linked to the names in the list of common friends, groups and bands.

Alternatively, for example, a few of the common friends, groups, and bands could be listed with a link to all of the common items. Importantly, the potential friend has many items in related as opposed to one item, such as attending the same school or members in one common group. This is related to why items as described in section 2, but section 2 was for likely items, and this is for related users. As such, the reason users are related (labeled why list) can only list items they both enjoy, and there's no similarity between the items and the user to rank the items.

Alternatively, the why list can be created by searching both users' likely items for the same items, linking to that item name (e.g. friend or group) and/or description via a secondary database (e.g. item database), and showing the name and/or description with the related user link.

Related and Likely Social Objects within Social Networks

As also shown in FIG. 8, the social network 800 has a database 810 with historical data 101, related social objects 813, likely social objects 815, and social object information 814. The social objects can be identified as related social objects 831 by any recommendation algorithm.

Related social objects 831 and social object information 832 can be combined to be displayed on the website 820 as related objects' information 832. This information 832 is displayed to the current user when they are viewing a social object's webpage 831 as related objects that you may like (such as groups, icons, etc.).

The social objects can be identified as likely social objects 841 by any recommendation algorithm. Likely social objects 841 and social object information 832 can be combined to be displayed on the website 820 as likely social objects' information 852. This information 852 is displayed to the current user when they are viewing any web page 851 as likely objects that they may like (such as groups, icons, etc.).

Related and likely social objects are used to help the user find other objects they will like. Related objects are displayed when viewing a specific object, using as links. For example, when viewing a group, other related groups can be listed. Likely objects can be displayed at any time the user is logged into the social network. For example, when the user is viewing their home page in the social network, a list of groups, music, and promotion pages that the user would enjoy can be shown. The lists usually include icons, images, names and/or descriptions and are obtained from the web site converting the recommend web service list of likely social objects IDs to object icons, names and/or description via the social object index.

Finally, the social network can use all of related users, related social objects and likely social objects, or any combination of them, as easily created given the above description.

8. Affinity Card and Recommendations

Affinity cards are cards that track purchases for one or more participating companies. They are usually a physical card that is read by a reader or cash register (e.g. Safeway card), but can also be an ID that is entered into the reader or cash register (e.g. REI). They are usually used to identify a user or family of users that share a card, track their actions (e.g. purchases, rentals, concerts attended, etc.) and offer them specials.

When available for one company, that company using maintains the card. When available for multiple participating companies, an affinity card manufacturer usually maintains the card and signs up participating companies, who may or may not want to share information with other participating companies. Affinity cards offer unique abilities to offer recommendations in a brick-and-mortar world because actions are tracked with the affinity card. Affinity cards are usually linked to the primary user's name, address, email address, cell phone/text number, home phone, and work phone, or all users' contact information. The affinity card also has an ID, and the user can set a password so they can access a website for affinity card users.

As shown in FIG. 9, the affinity card 910 can optionally keep track of its user's (or family of user's) action data 920. An affinity card reader 930 reads a card during an action, such as buying groceries. The reader 930 can optionally store that transaction on the affinity card in the user's action data 920, and must store the action at a remote system 950 in the historical data 960. The remote system can be maintained by the participating company and/or the affinity card manufacturer. The remote system 950 can be either (i) a generic computer, (ii) a storage location linked to a computing device used for recommendation training and have ability to electronically communicate with the reader 930, or (iii) a network of specialized devices capable of storing data, calculating recommendation training and communicating with the reader 930.

Periodic recommendation training, using any method applicable as described in this specification or elsewhere, is performed on the historical data 960. Most likely, the historical data 960 is non-rated, and a recommendation training that works with non-rated data is required. If the data is rated, an applicable recommendation method handles ratings, or a non-rated algorithm is used and the historical data includes non-rated actions and either (i) all actions converted to the same rating or (ii) only actions with a positive rating. The training determines items that an affinity card user is likely to act upon (a.k.a. likely items 970), as described in this specification and elsewhere.

The likely items 970 are either stored at the remote location 950 or created in real-time while the card is being read. One or more likely items can be associated with a discount, potentially only good for that day or for an hour, to entice the card user to act upon that item, e.g. purchase it. In either case, while the card is being read the one or more likely items and optional discounts are electronically transmitted to the reader and presented to the user. Since readers are usually in stores, the likely items can be printed out from a printer, such as the receipt printer, or displayed on the screen usually available at checkout, where the printer or screen are connected to the reader 930. The reader could also have its own printer or screen.

Alternatively, the likely item(s) and associated discount(s) could be stored for later access. Assuming that the user provided an email address, the likely items and discounts could be emailed or texted to a cell phone (box 980). They could be stored on a website linked to the affinity card, and accessible with an affinity card reader or via the affinity card ID and password. The advantage of the presentation in the store is that the user is already there and can be convinced to buy something new with an immediate and short-term (i.e. good only today) discount linked to their tastes.

If the historical data is maintained by one participating company, possibly the only participating company, the historical data can include actions from affinity cards and all other non-card actions if linked to a specific user. The card can be used to link physical store and online purchases, such that recommendations in the store and online use both purchases. The specific user doesn't need to have contact information, and could just be associated with a credit card, or something to aid in training, as the increase in historical data will improve recommendations.

If the historical data is maintained by the affinity card manufacturer, the historical data can include all affinity card transactions across multiple participating companies. In this latter case, when a recommended likely item and optional discount is presented to the card user at one participating company, that participating company may not want the likely item to be for another participating company. As such, the historical data includes a field for participating company ID, the reader sends participating company ID for each action, and only likely items and discounts for that participating company ID are presented to the card user when using a reader at that company.

Limiting the presentation to the participating company can happen in two fashions. First, the reader could send the participating company ID and the remote system only returns likely items for that participating company ID. Second, the remote system sends all likely items, with participating company ID included with each likely item, and the reader only presents likely items for that participating company ID. The first method is preferred. It is advantageous in that the remote system can guarantee a specific number, N, of likely items for each participating company by have the results of training include N likely items for each participating company—which are the most likely items for the customer to buy for each participating company ID. In other words, after training, the recommendation system finds N likely items for a user for each participating company. For the second method, the number of likely item, N, should be larger than the normal 10-20, like 100-200, such that it is likely that every participating company ID has at least one likely item.

Concluding Remarks

The foregoing descriptions of the preferred embodiments of the invention have been presented to teach those skilled in the art how to best utilize the invention. To provide a comprehensive disclosure without unduly lengthening the specification, the applicants incorporate by reference the patents, patent applications and other documents referenced above. Many modifications and variations are possible in light of the above teachings, including incorporated-by-reference patents, patent applications and other documents. For example, algorithms to determine related items based upon purchase habits can be applied to an action, such as playing, rating and/or viewing content. Methods to determine related items can be used to determine related users, and vice-versa.

What is claimed is:

1. A method for recommendations, comprising the steps of:
a. obtaining historical data from numerous users' actions with numerous items,
b. offline training with the historical data to calculate recommendation IDs,
c. saving the recommendation IDs for more than one item or more than one user, and
d. utilizing a recommendation component, which upon a request with a target ID and a client ID, in real-time, looks up the recommendations, and returns the recommendation IDs
wherein at least one of the steps utilizes a computing device.

2. The method of claim 1 wherein a website provides the historical data and utilizes the recommendation component, with the additional step of utilizing programming on the website to convert the recommended IDs to an image or description to display on the website.

3. The method of claim 1 wherein said recommendation component is a web service.

4. The method of claim 1 wherein said offline training is implemented as a computer program, historical data is exported to one or more files from a database, said exported one or more files are listed in a configuration file, and said configuration file is the input to said computer program.

5. The method of claim 1 wherein said recommendation component loads recommendation data for multiple clients and the correct client is chosen from a lookup table using said client ID.

6. The method of claim 1 wherein said historical data is obtained through direct links to a database, and loads all of the action data into memory of a remote computer.

7. The method of claim 1 wherein the historical data includes a category tag, and said category tag is used to determine if each recommendation should be removed if the user has already acted upon the item.

8. The method of claim 1 wherein the target ID is linked to a category ID, the historical actions are linked to categories through the one or more items, related categories are found through these actions, and the top selling items of the related categories are included as recommendations.

9. The method of claim 8 wherein there are more than one category type linked to each item, and within each category type, the related categories are calculated through the historical actions, and the recommendations include the similarity of more than one category with the target ID's category from the more than one category types.

10. The method of claim 1 wherein the target ID has one or more similar IDs, and the recommendation IDs for each similar ID is used as a recommendation for the target ID.

11. A method of calculating categorical related items, comprising the steps of:
a. obtaining historical data from numerous users' actions with numerous items, and a target items is linked to a target category,
b. determining the most related categories to the target category,
c. listing the top acted-upon items in each most related category,
d. calculating the weight based upon the top acted-upon item number of actions and the related category similarity, and
e. determining the categorical related items as the items with the largest weights,
wherein at least one of the steps utilizes a computing device.

12. The method of claim 11 wherein the weight depends upon the log of the number of actions of the top items and the square of the related category similarity.

13. The method of claim 11 wherein the target category may be related to itself depending upon calculating the self-similarity, and the self-similarity depends upon users with multiple actions in the target category.

14. The method of claim 12 wherein the self-similarity depends upon the number of users with multiple actions and by number of unique users, or number of actions by users with multiple actions and by total number of actions.

15. The method of claim 11 wherein there are more than one category type related to each item, and within each category type the related categories are calculated through the historical actions, and the recommendations include the similarity of more than one category type with the target categories from the more than one category type.

16. The method of claim 15 wherein there are two category types, one is brand and the other is product type, and the similarity of each category type is multiplied with each other and depends upon the number of actions for each top item to determine recommendations.

17. A method of calculating related categories, comprising the steps of:
a. obtaining historical data from numerous users' actions with numerous items, and each item is linked to at least on category,
b. choosing a target category,
c. determining the likelihood of acting on items in other category,
d. determining the likelihood of acting on items in the target category using self-similarity that depends upon users with multiple actions in said target category, and
e. finding the top most related categories to the target category;
wherein at least one of the steps utilizes a computing device.

18. The method of claim 17 wherein step c further includes using correlation based upon users that acted upon items in both categories.

19. The method of claim 17 wherein step d further utilizes the by number of unique users, or total number of actions.

20. The method of claim 17 wherein the results are displayed in a viewer where a computer-user gets to select the target category and view the top related categories.
